(19) United States
(12) Patent Application Publication
(10) Pub. No.: US 2017/0201766 A1
(43) Pub. Date: Jul. 13, 2017

(54) METHOD AND APPARATUS FOR CODING AND DECODING SCALABLE VIDEO DATA

(71) Applicant: SAMSUNG ELECTRONICS CO., LTD., Suwon-si (KR)

(72) Inventor: Byeong-doo CHOI, Suwon-si (KR)

(73) Assignee: SAMSUNG ELECTRONICS CO., LTD., Suwon-si (KR)

(21) Appl. No.: 15/320,598

(22) PCT Filed: Jun. 18, 2015
(86) PCT No.: PCT/KR2015/006161

§ 371 Date: Dec. 20, 2016

Related U.S. Application Data
(60) Provisional application No. 62/014,838, filed on Jun. 20, 2014.

(51) Int. Cl. H04N 19/50; H04N 19/159; H04N 19/187; H04N 19/184

(52) U.S. Cl. CPC H04N 19/50; H04N 19/184; H04N 19/159; H04N 19/187

(57) ABSTRACT

Provided is a method of decoding a scalable video comprising a plurality of layers, the method including: obtaining, from a bitstream, first information indicating a number lower than, by 1, a maximum number of layers allowed to refer to a video parameter set with respect to the scalable video from among layers included in each coded video sequence; decoding a first picture included in a first layer; and performing, by a second picture included in a second layer, at least one of inter-layer sample prediction and inter-layer motion prediction between the first layer and the second layer by referring to the decoded first picture, wherein the first layer is a base layer corresponding to a lowest layer of the plurality of layers, the second layer is a layer using a decoding method different from the first layer, and when the first and second layers use different decoding methods, the first information has a value higher than 0.

### TECHNICAL FIELD

The present disclosure relates to a method and apparatus for encoding or decoding video data by using a plurality of layers including images decoded by using different decoding method.

### BACKGROUND ART

Video data is encoded by a codec according to a certain data compression standard, for example, a moving picture expert group (MPEG) standard, and then stored in a recording medium in a form of a bitstream or transmitted through a communication channel.

Scalable video coding (SVC) is a video compression method for suitably adjusting and transmitting an amount of data in accordance with various communication networks and terminals. The SVC provides an image of a base layer and an enhancement layer adaptively used in various transmission networks and various receiving terminals.

Recently, a multiview video coding technology for 3-dimensional (3D) video coding is widely provided according to supply of 3D multimedia devices and 3D multimedia content.

As such, while encoding or decoding a picture included in each layer, another layer may be referred to in a recent method of encoding or decoding a scalable video by using a plurality of layers. In other words, in order to predict a sample while encoding or decoding a picture, another layer may be referred to. Encoding or decoding efficiency may be increased through such a referencing process.

However, an existing method used when a decoding method used by a picture of a base layer that is a reference target is different from a decoding method used by a picture of a layer to be referred to is difficult to perform and is inefficient. Accordingly, a method for efficiently encoding or decoding a picture through referencing between layers decoded by using different decoding methods needs to be provided.

### DETAILED DESCRIPTION OF THE INVENTION

### Technical Problem

Provided are methods and apparatuses for efficiently performing encoding or decoding using a plurality of layers including images decoded by using different decoding methods, by re-defining syntax or semantic required during encoding or decoding processes.

### Technical Solution

According to an aspect of an embodiment, a method of decoding a scalable video including a plurality of layers, the method includes: obtaining, from a bitstream, first information indicating a number lower than, by 1, a maximum number of layers allowed to refer to a video parameter set with respect to the scalable video from among layers included in each coded video sequence; decoding a first picture included in a first layer; and performing, by a second picture included in a second layer, at least one of inter-layer sample prediction and inter-layer motion prediction between the first layer and the second layer by referring to the decoded first picture, wherein the first layer is a base layer corresponding to a lowest layer of the plurality of layers, the second layer is a layer using a decoding method different from the first layer, and when the first and second layers use different decoding methods, the first information has a value higher than 0.

According to an aspect of another embodiment, an apparatus for decoding a scalable video including a plurality of layers, the apparatus includes: a first information obtainer configured to obtain, from a bitstream, first information indicating a number lower than, by 1, a maximum number of layers allowed to refer to a video parameter set with respect to the scalable video from among layers included in each coded video sequence; a first picture decoder configured to decode a first picture included in a first layer; and a second picture decoder configured to perform, by a second picture included in a second layer, at least one of inter-layer sample prediction and inter-layer motion prediction between the first layer and the second layer by referring to the decoded first picture, wherein the first layer is a base layer corresponding to a lowest layer of the plurality of layers, the second layer is a layer using a decoding method different from the first layer, and when the first and second layers use different decoding methods, the first information has a value higher than 0.

According to an aspect of another embodiment, a non-transitory computer-readable recording medium has recorded thereon a program which, when executed by a computer, preforms the method.

### Advantageous Effects of the Invention

According to an embodiment, when a scalable video including a plurality of layers is decoded, and a decoding method used by a picture of a base layer that is a reference target and a decoding method used by a picture of a layer to be referred to are different from each other, a picture may be efficiently decoded or encoded by re-defining syntax or a semantic required during decoding processes.

### DESCRIPTION OF THE DRAWINGS

FIG. 1A is a block diagram of a structure of a scalable video encoding apparatus encoding a scalable video, according to an embodiment.

FIG. 1B is a block diagram of a structure of a scalable video decoding apparatus decoding a scalable video, according to an embodiment.

FIG. 1C illustrates a semantic corresponding to first information, according to an embodiment.

FIG. 2A illustrates a method of an enhancement layer referencing a lower layer than the enhancement layer without determining whether a base layer and the enhancement layer are encoded or decoded by using different methods.

FIG. 2B illustrates a syntax element and semantic about whether to refer to scaling list data during scalable video encoding processes, according to an embodiment.

FIG. 2C illustrates processes of processing information about a maximum value of a temporal identifier for determining a picture of a referable layer between layers of a scalable video, according to an embodiment.

FIG. 2D illustrates a part of syntax of video usability information about a video parameter set, according to an embodiment.

FIG. 3A illustrates a scalable video including a plurality of layers, according to an embodiment.

FIG. 3B illustrates a scalable video encoding system according to an embodiment.

FIG. 4A is a diagram of a network abstraction layer (NAL) unit header according to an embodiment.

FIG. 4B illustrates NAL units including encoded data of a scalable video, according to an embodiment.

FIG. 5 is a diagram for describing a layer set according to various embodiments.

FIG. 6 is a diagram for describing an output layer subset.

FIG. 7 illustrates a block diagram of a video encoding apparatus based on coding units of a tree structure, according to an embodiment.

FIG. 8 illustrates a block diagram of a video decoding apparatus based on coding units of a tree structure, according to an embodiment.

FIG. 9 illustrates a concept of coding units, according to an embodiment.

FIG. 10 illustrates a block diagram of an image encoder based on coding units, according to an embodiment.

FIG. 11 illustrates a block diagram of an image decoder based on coding units, according to an embodiment.

FIG. 12 illustrates deeper coding units according to depths, and partitions, according to an embodiment.

FIG. 13 illustrates a relationship between a coding unit and transformation units, according to an embodiment.

FIG. 14 illustrates a plurality of pieces of encoding information according to depths, according to an embodiment.

FIG. 15 illustrates deeper coding units according to depths, according to an embodiment.

FIGS. 16, 17, and 18 illustrate a relationship between coding units, prediction units, and transformation units, according to embodiments.

FIG. 19 illustrates a relationship between a coding unit, a prediction unit, and a transformation unit, according to encoding mode information of Table 1.

FIG. 20 illustrates a physical structure of a disc in which a program is stored, according to an embodiment.

FIG. 21 illustrates a disc drive for recording and reading a program by using the disc.

FIG. 22 illustrates an overall structure of a content supply system for providing a content distribution service.

FIGS. 23 and 24 illustrate external and internal structures of a mobile phone to which a video encoding method and a video decoding method are applied, according to an embodiment.

FIG. 25 illustrates a digital broadcasting system employing a communication system according to an embodiment.

FIG. 26 illustrates a network structure of a cloud computing system using a video encoding apparatus and a video decoding apparatus, according to an embodiment.

### BEST MODE

According to an aspect of an embodiment, a method of decoding a scalable video including a plurality of layers, the method includes: obtaining, from a bitstream, first information indicating a number lower than, by 1, a maximum number of layers allowed to refer to a video parameter set with respect to the scalable video from among layers included in each coded video sequence; decoding a first picture included in a first layer; and performing, by a second picture included in a second layer, at least one of inter-layer sample prediction and inter-layer motion prediction between the first layer and the second layer by referring to the decoded first picture, wherein the first layer is a base layer corresponding to a lowest layer of the plurality of layers, the second layer is a layer using a decoding method different from the first layer, and when the first and second layers use different decoding methods, the first information has a value higher than 0.

The method may further include obtaining, from the bitstream, second information about whether the first layer and the second layer use a same decoding method, wherein, when the second information indicates that the first and second layers use different decoding methods, the first information may have a value higher than 0.

A value of an identifier of a network abstraction layer (NAL) unit with respect to a video parameter set referred to by the second layer may have a value higher than 0.

The referring to the decoded first picture may include, when the plurality of layers are not referred to in a same manner, referring to at least one lower layer corresponding to a layer lower than the second layer from among the plurality of layers without determining whether the first and second layers use a same decoding method, wherein the at least one lower layer may include the first layer.

The preforming of at least one of the inter-layer sample prediction and the inter-layer motion prediction may include: when it is determined that the second layer directly refers to the at least one lower layer, obtaining, from the bitstream, third information about a method of referring, by the second layer, to the at least one lower layer; and performing at least one of the inter-layer sample prediction and the inter-layer motion prediction between the first and second layers based on the third information.

The method may further include: obtaining, from the bitstream, second information indicating whether the first and second layers use a same decoding method; and when the second information indicates that the first and second layers use different decoding methods, obtaining fourth information indicating that the second layer does not refer to scaling list data on a sequence parameter set of the first layer.

The method may further include: obtaining, from the bitstream, second information indicating whether the first and second layers use a same decoding method; and when the second information indicates that the first and second layers use different decoding methods, obtaining fifth information indicating that the second layer does not refer to scaling list data on a picture parameter set of the first layer.

The method may further include: obtaining, from the bitstream, second information indicating whether the first and second layers use a same decoding method; when the second information indicates that the first and second layers use different decoding methods, obtaining, from the bitstream, sixth information including information about a maximum value of a temporal identifier of the second picture that is referred to by a third picture included in a third layer that is one of the plurality of layers; and referring, by the third picture, to a picture having a value of a temporal identifier equal to or lower than the maximum value from the second picture based on the sixth information, wherein the third layer may correspond to an upper layer of the second layer.

The obtaining of the sixth information may include determining a maximum value of a temporal identifier of the first picture that is referred to by the second picture, as a pre-determined value of a temporal identifier.

The method may further include, after decoding of pictures referring to the first picture is completed, setting a reconstruction picture stored in a sub-decoding picture buffer of the first layer to an empty state.

The method may further include: obtaining, from the bitstream, second information indicating whether the first and second layers use a same decoding method; and when the second information indicates that the first and second layers use different decoding methods, obtaining, from the bitstream, seventh information indicating whether a limitation of referring to a picture parameter set and a sequence parameter set of the first picture is applied while determining a picture parameter set and a sequence parameter set of the second picture, wherein the seventh information may indicate that the limitation is not always applied.

The method may further include: obtaining, from the bitstream, second information indicating whether the first and second layers use a same decoding method; and when the second information indicates that the first and second layers use different decoding methods, obtaining, from the bitstream, eighth information indicating a maximum value of a layer identifier allowed in a coded video sequence referring to a video parameter set regarding the scalable video, wherein the maximum value may be higher than 1.

The method may further include: obtaining, from the bitstream, second information indicating whether the first and second layers use a same decoding method; and when the second information indicates that the first and second layers use different decoding methods, obtaining, from the bitstream, ninth information indicating whether a limitation that data units of all video encoding layers included in an access unit of the scalable video have a same layer identifier or a limitation that a data unit of a video encoding layer of an access unit of the scalable video comprises an intra random access point (IRAP) picture is applied, wherein the ninth information may indicate that the limitation is not always applied.

According to an aspect of another embodiment, an apparatus for decoding a scalable video comprising a plurality of layers, the apparatus includes: a first information obtainer configured to obtain, from a bitstream, first information indicating a number lower than, by 1, a maximum number of layers allowed to refer to a video parameter set with respect to the scalable video from among layers included in each coded video sequence; a first picture decoder configured to decode a first picture included in a first layer; and a second picture decoder configured to perform, by a second picture included in a second layer, at least one of inter-layer sample prediction and inter-layer motion prediction between the first layer and the second layer by referring to the decoded first picture, wherein the first layer is a base layer corresponding to a lowest layer of the plurality of layers, the second layer is a layer using a decoding method different from the first layer, and when the first and second layers use different decoding methods, the first information has a value higher than 0.

According to an aspect of another embodiment, a non-transitory computer-readable recording medium has recorded thereon a program which, when executed by a computer, preforms the method.

### MODE OF THE INVENTION

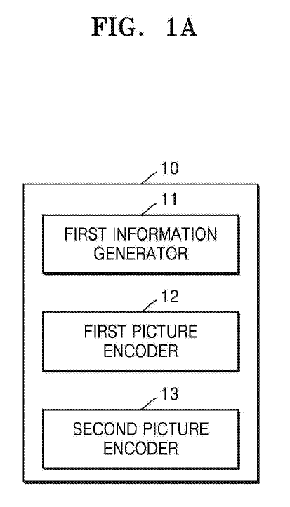

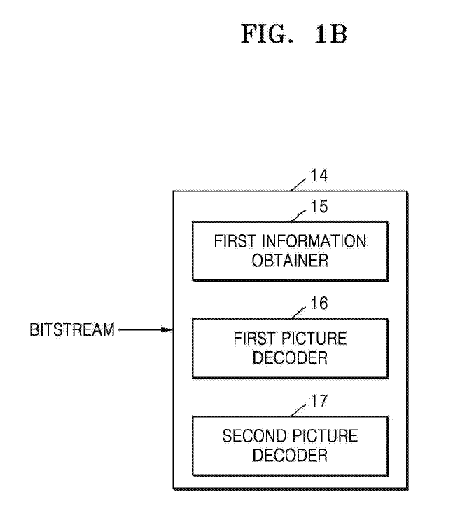

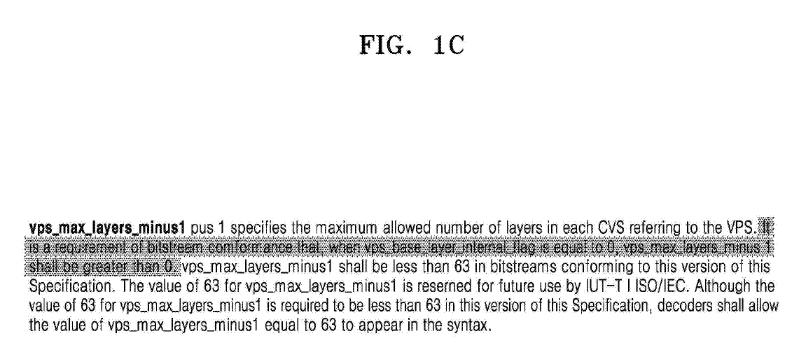

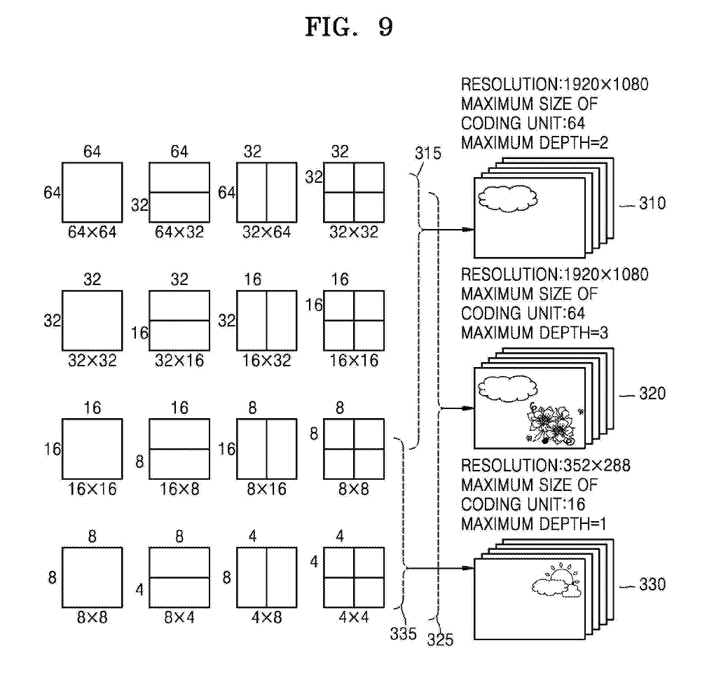

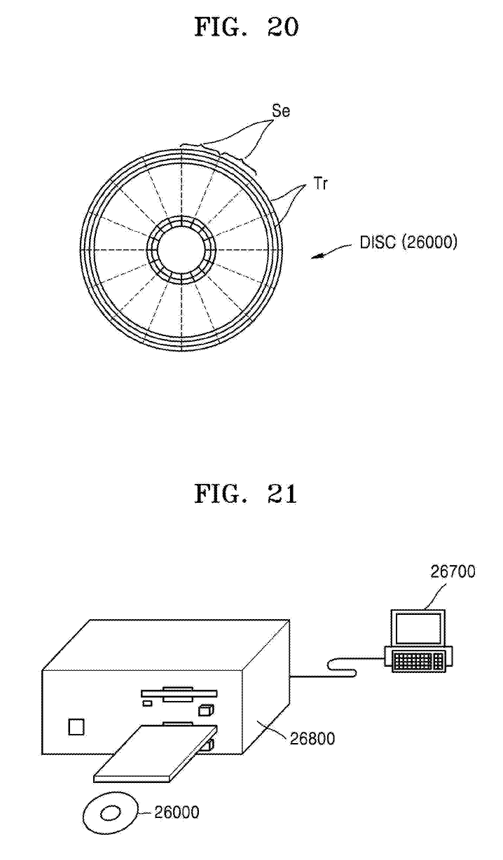

Hereinafter, scalable video encoding methods or decoding methods are suggested according to various embodiments, with reference to FIGS. 1A through 6. Also, video encoding techniques and video decoding techniques based on coding units of a tree structure, according to various embodiments, which are applicable to depth image decoding techniques and depth image encoding techniques suggested above, will be described with reference to FIGS. 7 through 20. Also, various embodiments to which video encoding methods and video decoding methods described above are applicable will be described with reference to FIGS. 20 through 26.

Hereinafter, an “image” may indicate a still image of a video or a moving picture, i.e., the video itself.

Hereinafter, a “sample” is data assigned to a sampling location of an image, and denotes data to be processed. For example, pixels in an image of a spatial domain may be samples.

Hereinafter, a “scalable video” may denote a multilayer video forming video content that may be output by using a plurality of layers. The same video content may be output in temporally, spatially, or qualitatively different formats based on a method of encoding video data including a plurality of layers.

FIG. 1A is a block diagram of a structure of a scalable video encoding apparatus 10 encoding a scalable video, according to an embodiment.

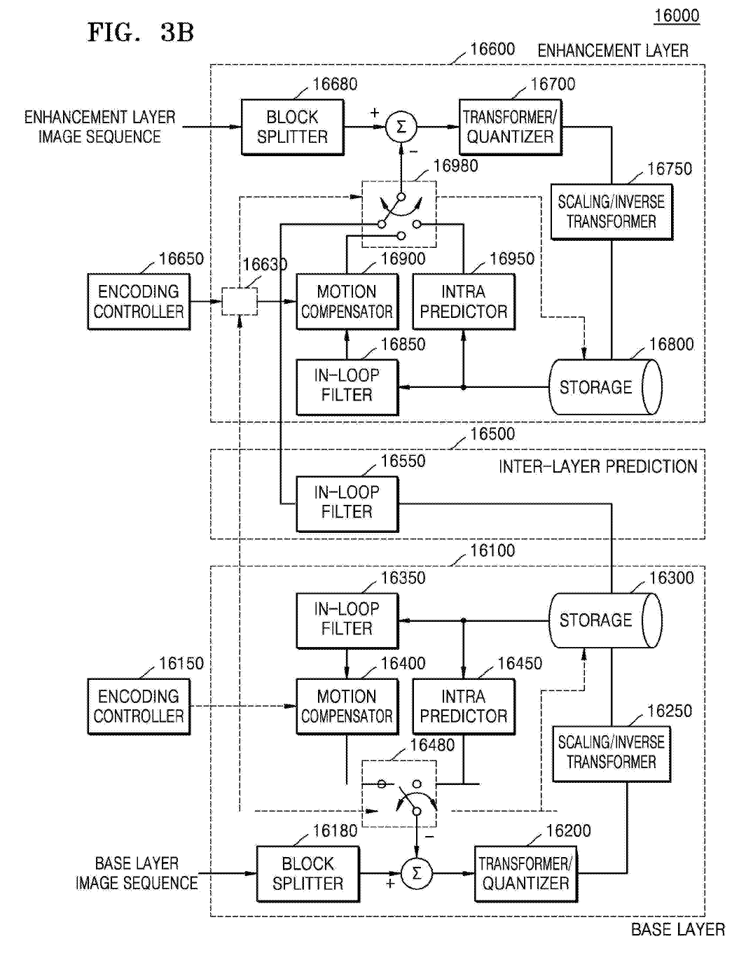

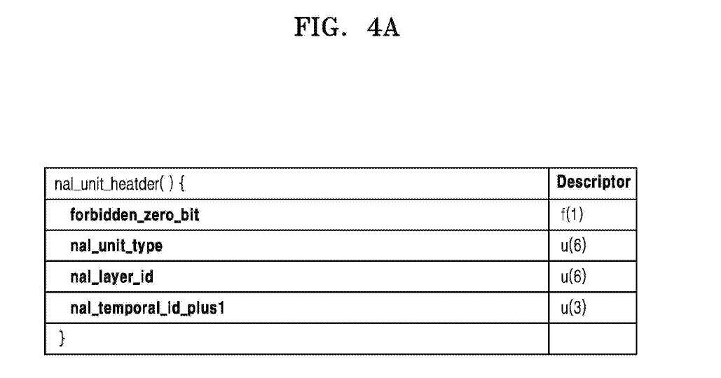

The scalable video encoding apparatus 10 according to an embodiment may perform an encoding process using a plurality of layers forming a scalable video. In other words, a scalable video may be encoded by using a plurality of layers such that video content may be output in a video sequence having various types of quality. Such a scalable video will be described in detail below with reference to FIG. 3A.

The scalable video encoding apparatus 10 according to an embodiment may include a first information generator 11 generating a bitstream including first information indicating a number lower than, by 1, the maximum number of layers supported in a method of encoding or decoding a scalable video. In other words, the first information generator 11 may generate a bitstream including the first information, and the maximum number of layers supported in a method of encoding a scalable video may be determined by using the first information. Accordingly, the scalable video encoding apparatus 10 may determine, as the maximum number of layers supported in a method of decoding a video, a value higher than, by 1, a value corresponding to the first information.

According to an embodiment, a scalable video may include a plurality of layers including a first layer and a second layer. The first layer may be a lowest layer of the plurality of layers. The lowest layer may be a base layer that is the most fundamental layer of the plurality of layers. In other words, the first layer may be a layer having the smallest value of a layer identifier used to distinguish the plurality of layers, wherein a layer identifier may be an identifier included in a network abstraction layer (NAL) unit header of a layer, and a value of the layer identifier of the first layer may be 0. According to an embodiment, the second layer may be a layer different from the base layer from among the plurality of layers, and may correspond to an upper layer of the first layer that is the base layer. In other words, a value of a layer identifier of the second layer may be higher than the value of the layer identifier of the first layer.

The scalable video encoding apparatus 10 according to an embodiment may include a first picture encoder 12 encoding a first picture included in the first layer of the plurality of layers. The scalable video encoding apparatus 10 may encode a video sequence including an access unit including at least one layer including the first layer. The first picture encoder 12 included in the scalable video encoding apparatus 10 may encode the first picture included in the first layer.

The scalable video encoding apparatus 10 according to an embodiment may include a second picture encoder 13 encoding a second picture included in the second layer of the plurality of layers. The scalable video encoding apparatus 10 may encode a video sequence including at least one layer including the second layer.

The scalable video encoding apparatus 10 according to an embodiment may refer to the first picture encoded by the first picture encoder 12, so as to encode the second picture. In other words, in order to encode a picture included in the second layer, a picture included in the first layer corresponding to a layer different from the second layer may be referred to. The scalable video encoding apparatus 10 may efficiently manage a bitstream required to encode the second picture as a picture of the second layer that is an enhancement layer refers to a picture forming the base layer when the first layer is the base layer. However, when encoding or decoding methods between the first layer that is the base layer and the second layer that is the enhancement layer are different, an unnecessary process may be performed during a mutual referring process. Accordingly, according to an embodiment, in order to perform efficient encoding or decoding processes when encoding or decoding methods between the first layer and the second layer are different, an efficient encoding or decoding method may be provided by re-defining syntax or symantic and omitting an unnecessary process.

According to an embodiment, when the base layer and the enhancement layer forming a scalable video encoded by the scalable video encoding apparatus 10 use different methods, the scalable video encoding apparatus 10 may perform encoding processes based on a premise that a plurality of layers refer to a video parameter set (VPS) of the scalable video, based on the first information. For example, when the first information indicates that one layer refers to the VPS of the scalable video despite that a video being currently encoded corresponds to a scalable video including a plurality of layers, and a base layer and an enhancement layer from among the plurality of layers use different encoding methods, it may be determined that an error is generated during encoding processes of the scalable video encoding apparatus 10 or that an error is generated during decoding processes performed by a scalable video decoding apparatus 14 obtaining a coded video sequence (CVS).

FIG. 1B is a block diagram of a structure of the scalable video decoding apparatus 14 decoding a scalable video, according to an embodiment.

The scalable video decoding apparatus 14 according to an embodiment may perform decoding processes using at least one layer from among a plurality of layers so as to reproduce a scalable video. In other words, the scalable video may be decoded by using the plurality of layers such that video content is output in a video sequence having various types of quality.

The scalable video decoding apparatus 14 according to an embodiment may include a first information obtainer 15 obtaining, from a bitstream, first information indicating a number lower than, by 1, a maximum number of layers supported in a method of encoding or decoding a scalable video. In other words, the maximum number of layers supported in a method of decoding a video may be determined by using the first information obtainer 15 obtained by the first information obtainer 15. Accordingly, the scalable video decoding apparatus 14 may determine, as the maximum number of layers supported in a method of decoding a video, a value higher than, by 1, a value corresponding to the first information.

According to an embodiment, a scalable video decoded by the scalable video decoding apparatus 14 may include a plurality of layers including a first layer and a second layer. The first layer may be a lowest layer of the plurality of layers. The lowest layer may be a base layer that is the most fundamental layer of the plurality of layers. In other words, the first layer may be a layer having the smallest value of a layer identifier used to distinguish the plurality of layers, wherein a layer identifier may be an identifier included in an NAL unit header of a layer, and a value of the layer identifier of the first layer may be 0. According to an embodiment, the second layer may be a layer different from the base layer from among the plurality of layers, and may correspond to an upper layer of the first layer that is the base layer. In other words, a value of a layer identifier of the second layer may be higher than the value of the layer identifier of the first layer.

The scalable video decoding apparatus 14 according to an embodiment may include a first picture decoder 16 decoding a first picture included in the first layer of the plurality of layers. The scalable video decoding apparatus 14 may decode a video sequence including an access unit including at least one layer including the first layer. The first picture decoder 16 included in the scalable video decoding apparatus 14 may decode the first picture included in the first layer.

The scalable video decoding apparatus 14 according to an embodiment may include a second picture decoder 17 decoding a second picture included in the second layer of the plurality of layers. The scalable video decoding apparatus 14 may decode a video sequence including at least one layer including the second layer.

According to an embodiment, when the base layer and the enhancement layer forming a scalable video decoded by the scalable video decoding apparatus 14 use different methods, the scalable video decoding apparatus 14 may perform decoding processes based on a premise that a plurality of layers refer to a VPS of the scalable video, based on the first information. For example, when the first information indicates that one layer refers to the VPS of the scalable video despite that a video being currently decoded corresponds to a scalable video including a plurality of layers, and a base layer and an enhancement layer from among the plurality of layers use different encoding methods, it may be determined that an error is generated during encoding processes of the scalable video encoding apparatus 10 or that an error is generated during decoding processes performed by a scalable video decoding apparatus 14 obtaining a CVS.

According to an embodiment, the scalable video encoding apparatus 10 may generate a bitstream including second information that is information about whether a base layer and an enhancement layer forming a scalable video use the same encoding method. For example, when the first layer that is the base layer and the second layer that is the enhancement layer are encoded by using the same encoding method, the second information may have a value higher than 0, i.e., 1. On the other hand, when the first layer that is the base layer and the second layer that is the enhancement layer are encoded by using different encoding methods, the second information may have a value of 0. Accordingly, by using the second information, a decoding apparatus, i.e., a receiver of the bitstream, may determine whether the base layer and the enhancement layer are encoded by using the same encoding method.

According to an embodiment, when the second information has a nonzero value because the base layer and the enhancement layer forming the scalable video use different encoding methods, the first information indicating the maximum number of layers allowed to refer to the VPS with respect to the scalable video from among the layers included in the video sequence may have a value higher than 0. In other words, when the base layer and the enhancement layer forming the scalable video use different encoding methods, the scalable video encoding apparatus 10 may generate the bitstream including the first information indicating that the plurality of layers refer to the VPS of the scalable video and the second information having a value of 0.

According to an embodiment, the scalable video decoding apparatus 14 may obtain, from the bitstream, the second information about whether the base layer and the enhancement layer forming the scalable video use the same encoding method. For example, when the first layer that is the base layer and the second layer that is the enhancement layer are encoded by using the same encoding method, the second information may have a value higher than 1, i.e., 0. On the other hand, when the first layer that is the base layer and the second layer that is the enhancement layer are encoded by using different encoding methods, the second information may have a value of 0. Accordingly, the scalable video decoding apparatus 14 that obtained the second information may determine whether the base layer and the enhancement layer are encoded by using the same encoding method, based on the second information.

According to an embodiment, when the second information has a nonzero value because the base layer and the enhancement layer forming the scalable video use different encoding methods, the first information indicating the maximum number of layers allowed to refer to the VPS with respect to the scalable video from among the layers included in the video sequence may have a value higher than 0. In other words, when the base layer and the enhancement layer forming the scalable video use different encoding methods, the scalable video decoding apparatus 14 may obtain, from the bitstream, the first information indicating that the plurality of layers refer to the VPS of the scalable video and the second information having a value of 0. Accordingly, when it is determined that the base layer and the enhancement layer use different encoding methods according to the obtained second information, the scalable video decoding apparatus 14 may determine that the plurality of layers refer to the VPS of the scalable video.

FIG. 1C illustrates semantic corresponding to first information, according to an embodiment.

Referring to FIG. 1C, according to an embodiment, the first information may include information about a maximum value of the number of layers referring a VPS. For example, the maximum number of layers referring to a VPS of a video being currently encoded/decoded may be determined by adding 1 to vps_max_layers_minus1 corresponding to the first information. The vps_max_layers_minus1 may indicate a value higher than 0 when a base layer and an enhancement layer forming a scalable video use different encoding methods according to a bitstream conformance request. In other words, when the base layer and the enhancement layer forming the scalable video use different encoding methods, vps_max_layers_minus1+1 may correspond to the maximum value of the number of layers referring to the VPS of the scalable video.

According to an embodiment, the scalable video encoding apparatus 10 may generate a bitstream including a VPS NAL unit in which a value of an identifier of an NAL unit with respect to a VPS of a scalable video is higher than 0. When a base layer and an enhancement layer forming the scalable video may be encoded by using the same method, the scalable video encoding apparatus 10 may generate a bitstream including a VPS NAL unit in which an identifier of an NAL unit with respect to a VPS referred to by the enhancement layer indicates 0. On the other hand, when a base layer and an enhancement layer forming the scalable video are encoded by using different encoding methods according to an embodiment, the scalable video encoding apparatus 10 may generate a bitstream including a VPS NAL unit in which an identifier of an NAL unit with respect to a VPS referred to by the enhancement layer has a value higher than 0.

According to an embodiment, the scalable video decoding apparatus 14 may obtain, from a bitstream, a VPS NAL unit in which a value of an identifier of an NAL unit with respect to a VPS of a scalable video has a value higher than 0. When a base layer and an enhancement layer forming the scalable video may be encoded by using the same method, the scalable video decoding apparatus 14 may obtain, from a bitstream, a VPS NAL unit in which an identifier of an NAL unit with respect to a VPS referred to by the enhancement layer indicates 0. On the other hand, when a base layer and an enhancement layer forming the scalable video are decoded by using different decoding methods, the scalable video decoding apparatus 14 may obtain, from a bitstream, a VPS NAL unit indicating that an identifier of an NAL unit with respect to a VPS referred to by the enhancement layer has a value higher than 0.

According to an embodiment, when the scalable video encoding apparatus 10 encodes a first layer that is a base layer and a second layer that is an enhancement layer, which form a scalable video to be encoded, by using different methods, the scalable video encoding apparatus 10 may perform encoding processes based on a premise that a plurality of layers refer to a VPS of the scalable video based on first information. When the base layer and the enhancement layer are encoded by using different methods, a bitstream including a VPS NAL unit in which an identifier of an NAL unit with respect to a VPS referred to by the second layer has a value higher than 0 may be generated.

According to an embodiment, when a first layer that is a base layer and a second layer that is an enhancement layer, which form a scalable video to be decoded by the scalable video decoding apparatus 14, are decoded by using different methods, the scalable video decoding apparatus 14 may perform decoding processes based on a premise that a plurality of layers refer to a VPS of the scalable video based on first information. When the first layer and the second layer are decoded by using different methods, a VPS NAL unit in which an identifier of an NAL unit with respect to a VPS referred to by the second layer has a value higher than 0 may be obtained from a bitstream.

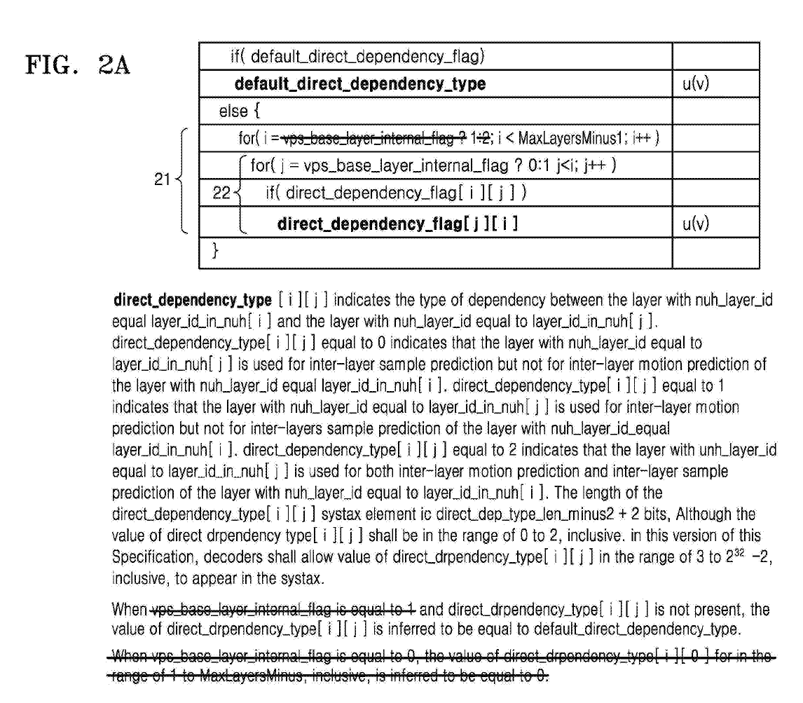

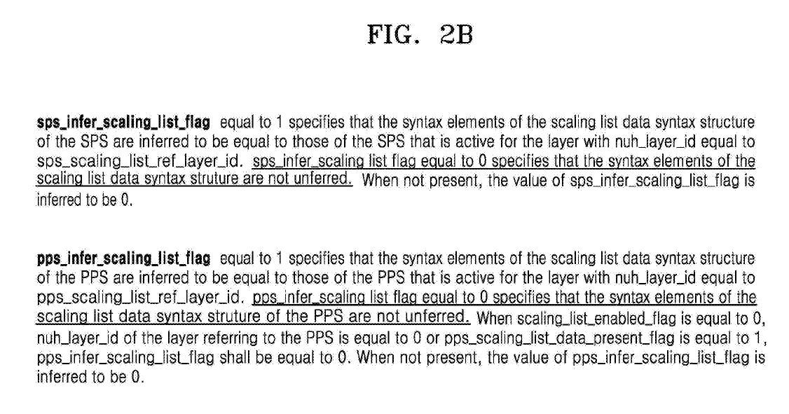

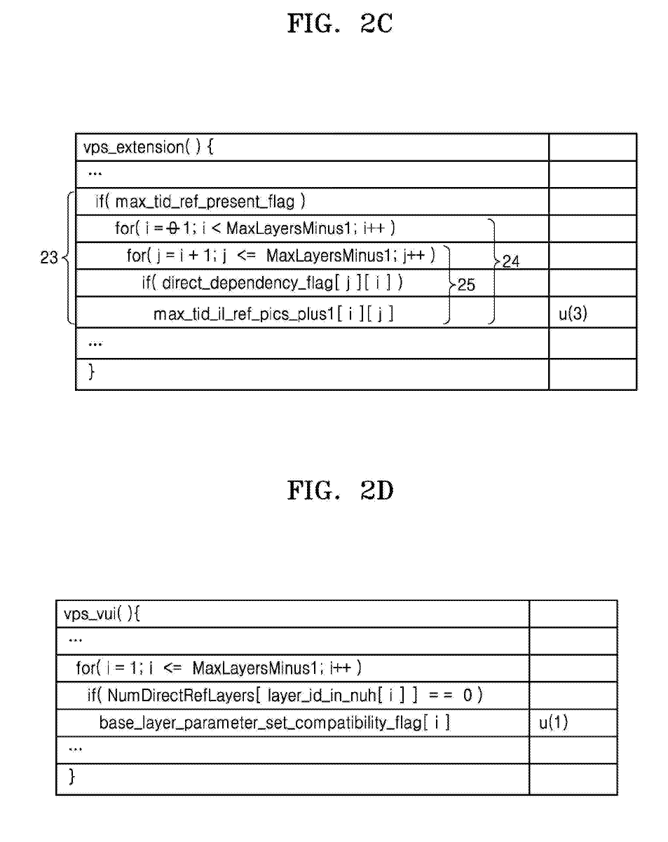

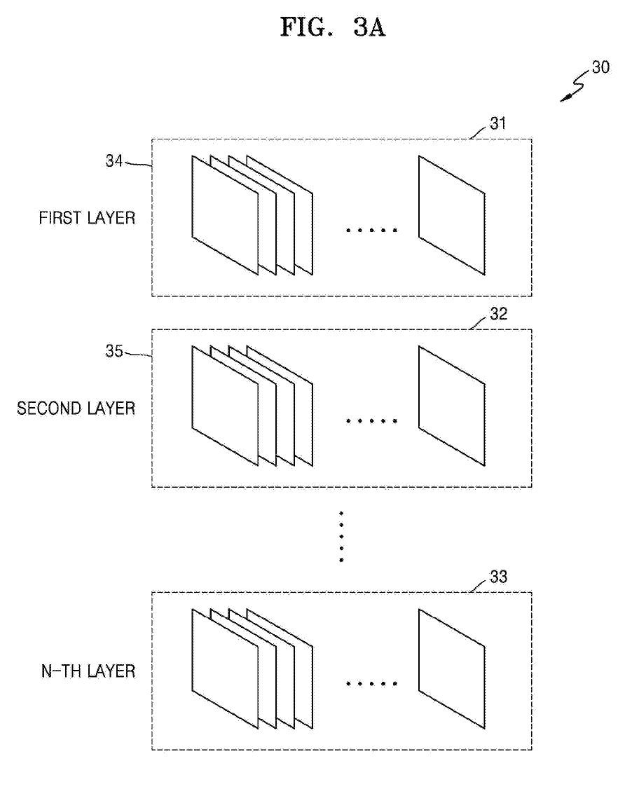

FIG. 2A illustrates a method of an enhancement layer referencing a lower layer than the enhancement layer without determining whether a base layer and the enhancement layer are encoded or decoded by using different methods.

According to an embodiment, a direct dependent layer may be a layer to which a certain layer directly refers. A j-th layer directly dependent on an i-th layer may be referred to during an inter-layer prediction process of the i-th layer. For example, when a layer having a layer identifier of 2 refers to a layer having a layer identifier of 1, and the layer having the layer identifier of 1 refers to a layer having a layer identifier of 0, a dependent layer of the layer having the layer identifier of 2 includes a direct dependent layer (the layer having the layer identifier of 1). Also, a dependent layer of the layer having the layer identifier of 2 may include an indirect dependent layer (the layer having the layer identifier of 0). Inter-layer prediction according to an embodiment may include inter-layer sample prediction and inter-layer motion prediction, and inter-layer prediction between direct dependent layers will be described in detail below with reference to FIG. 3B.

When a first layer that is a base layer and a second layer that is an enhancement layer, which form a scalable video encoded by the scalable video encoding apparatus 10, are encoded by using different methods according to an embodiment, the scalable video encoding apparatus 10 may encode the second layer by referring to at least one layer corresponding to a lower layer than the second layer regardless of whether the first and second layers are encoded by using different methods. Referring to FIG. 2A, the scalable video encoding apparatus 10 may determine that the i-th layer is directly dependent on the j-th layer based on information (for example, direct_dependency_flag[i][j]) indicating direct dependency between the i-th layer and the j-th layer. When it is determined that the i-th layer is directly dependent on the j-th layer, the scalable video encoding apparatus 10 may generate a bitstream including information (for example, direct_dependency_type[i][j]) about a method of the i-th layer, from among at least one layer forming a scalable video, referring to the j-th layer that is a lower layer than the i-th layer. According to an embodiment, the i-th layer may correspond to one of the at least one layer aside from the base layer, and the j-th layer referred to by the i-th layer corresponds to a lower layer than the i-th layer. According to an embodiment, the scalable video encoding apparatus 10 may determine a layer starting to preform a for-loop 21 with respect to the i-layer as a lowest layer of the at least one layer aside from the base layer, regardless of whether the base layer and the enhancement layer forming the scalable video are encoded by using different methods. The scalable video encoding apparatus 10 may perform a for-loop 22 with respect to the determined j-th layer, wherein the j-th layer may be one of the at least one layer that is a lower layer of the i-th layer and includes the base layer.

Referring to FIG. 2A according to an embodiment, the scalable video encoding apparatus 10 may generate a bitstream including a flag (for example, default_direct_dependency_flag) indicating whether prediction is to be performed on all layers forming a scalable video by using the same method. When the flag indicates that the prediction is performed on the all layers forming the scalable video by using the same method, a bitstream including syntax (for example, default_direct_dependecy_type) indicating at least one of inter-layer sample prediction and inter-layer motion prediction to be identically performed on the all layers.

However, when the prediction is not performed on the all layers forming the scalable video by using the same method, the scalable video encoding apparatus 10 may perform the for-loop 21 with respect to the i-th layer. The scalable video encoding apparatus 10 may repeat the for-loop 21 until a value of i is equal to the maximum number of layers−1 ((for(i=1; i<=vps_max_layers_minus1; i++)), and until a value of j per I is equal to i−1, and when the i-th layer having an index of i is directly dependent on the j-th layer having an index of j (if(direct_dependency_flag[i][j])), may generate a bitstream including third information (for example, direct_dependency_type[i][j]) that is information indicating a type of inter-layer prediction performed on the i-th layer by using the j-th layer.

Meanwhile, when it is determined that all direct dependent layers of a layer having a layer identifier of iNuhLid are used to perform inter-layer sample prediction and inter-layer motion prediction on the layer having the layer identifier of iNuhLid, the scalable video encoding apparatus 10 may determine that the all direct dependent layers of the layer having the layer identifier of iNuhLid are used to perform inter-layer sample prediction and inter-layer motion prediction on the layer having the layer identifier of iNuhLid, and perform the inter-layer sample prediction and motion prediction on the layer having the layer identifier of iNuhLid by using the all direct dependent layers.

According to an embodiment, when a first layer that is a base layer and a second layer that is an enhancement layer, which form a scalable video to be decoded by the scalable video decoding apparatus 14, are decoded by using different methods, the scalable video decoding apparatus 14 may decode the second layer by referring to at least one layer corresponding to a lower layer than the second layer, regardless of whether the first and second layers are decoded by using different methods. Referring to FIG. 2A, the scalable video decoding apparatus 14 may determine that the i-th layer is directly dependent on the j-th layer based on information (for example, direct_dependency_flag[i][j]) about direct dependency between the i-th layer and the j-th layer. When it is determined that the i-th layer is directly dependent on the j-th layer, the scalable video decoding apparatus 14 may obtain, from a bitstream, information (for example, direct_dependency_type[i][j]) about a method of the i-th layer from among at least one layer forming a scalable video referring to the j-th layer that is a lower layer than the i-th layer. According to an embodiment, the i-th layer may correspond to one of at least one layer aside from the base layer, and the j-th layer that is a layer to which the i-th layer refers corresponds to a lower layer of the i-th layer. According to an embodiment, the scalable video decoding apparatus 14 may determine a layer starting to preform the for-loop 21 with respect to the i-layer as a lowest layer of the at least one layer aside from the base layer, regardless of whether the base layer and the enhancement layer forming the scalable video are encoded by using different methods. The scalable video decoding apparatus 14 may perform the for-loop 22 with respect to the determined j-th layer, wherein the j-th layer may be one of the at least one layer that is a lower layer of the i-th layer and includes the base layer.

Referring to FIG. 2A according to an embodiment, the scalable video decoding apparatus 14 may obtain, from a bitstream, a flag (for example, default_direct_dependency_flag) indicating whether prediction is to be performed on all layers forming a scalable video by using the same method. When the flag indicates that the prediction is performed on the all layers forming the scalable video by using the same method, syntax (for example, default_direct_dependecy_type) indicating at least one of inter-layer sample prediction and inter-layer motion prediction to be identically performed on the all layers may be obtained from a bitstream.

However, when the prediction is not performed on the all layers forming the scalable video by using the same method, the scalable video decoding apparatus 14 may perform the for-loop 21 with respect to the i-th layer. The scalable video decoding apparatus 14 may repeat the for-loop 21 until a value of i is equal to the maximum number of layers−1 ((for(i=1; i<=vps_max_layers_minus1; i++)), and until a value of j per l is equal to i−1, and when the i-th layer having an index of i is directly dependent on the j-th layer having an index of j (if(direct_dependency_flag[i][j])), may obtain, from a bitstream, third information (for example, direct_dependency_type[i][j]) that is information indicating a type of inter-layer prediction performed on the i-th layer by using the j-th layer.

Meanwhile, when it is determined that all direct dependent layers of a layer having a layer identifier of iNuhLid are used to perform inter-layer sample prediction and inter-layer motion prediction on the layer having the layer identifier of iNuhLid, the scalable video decoding apparatus 14 may determine that the all direct dependent layers of the layer having the layer identifier of iNuhLid are used to perform inter-layer sample prediction and inter-layer motion prediction on the layer having the layer identifier of iNuhLid, and perform the inter-layer sample prediction and motion prediction on the layer having the layer identifier of iNuhLid by using the all direct dependent layers.

Meanwhile, it has been described above that the scalable video encoding apparatus 10 or the scalable video decoding apparatus 14 according to an embodiment perform inter-layer prediction by using the same prediction method on all layers when it is determined that prediction is performed on the all layers forming a scalable video by using the same method, but an embodiment is not limited thereto, and which one of inter-layer motion prediction and inter-layer sample prediction is to be performed by using a dependent layer may be pre-set as a default and performing of inter-layer motion prediction or inter-layer prediction may be determined based on the default. Meanwhile, the scalable video encoding apparatus 10 or the scalable video decoding apparatus 14 according to an embodiment describe inter-layer sample prediction and inter-layer motion prediction as an inter-layer prediction type, but an embodiment is not limited thereto, and a prediction target (sample, motion, or the like) may vary while performing inter-layer prediction.

According to an embodiment, the scalable video encoding apparatus 10 may generate, from a bitstream, second information indicating whether a base layer and an enhancement layer, which form a scalable video, use the same encoding method. For example, when a first layer that is the base layer and a second layer that is the enhancement layer are encoded by using the same encoding method, the second information may have a value higher than 0, i.e., 1. However, when the first layer that is the base layer and the second layer that is the enhancement layer are encoded by using different encoding methods, the second information may have a value of 0. When the second information obtained according to an embodiment indicates that the first layer and the second layer are encoded by using different encoding methods, it may be difficult to perform inter-layer motion prediction between the first and second layers. Accordingly, it may be efficient not to refer to scaling list data that may be referred to during inter-layer motion prediction that may be performed when the first and second layers are encoded by using the same method.

FIG. 2B illustrates a syntax element and semantic about whether to refer to scaling list data during scalable video encoding processes, according to an embodiment.

According to an embodiment, when second information indicates that a first layer and a second layer are encoded by using different methods, the scalable video encoding apparatus 10 may generate a bitstream including fourth information indicating that the second layer does not refer to scaling list data on a sequence parameter set of the first layer. When the fourth information (for example, sps_infer_scaling_list_flag) that is information about reference of syntax with respect to scaling list data indicates that the scaling list data is not referred to (for example, when the fourth information has a value of 0), the scalable video encoding apparatus 10 may not refer to a syntax structure about the scaling list data based on the fourth information.

Also, according to another embodiment, when the obtained second information indicates that the first and second layers are encoded by using different methods, the scalable video encoding apparatus 10 may generate a bitstream including fifth information indicating that the second layer does not refer to scaling list data on a picture parameter set of the first layer. When the fifth information (for example, pps_infer_scaling_list_flag) is information about reference of syntax with reference to scaling list data indicates that the scaling list data is not referred to (for example, when the fifth information has a value of 0), the scalable video encoding apparatus 10 may not refer to a syntax structure about the scaling list data based on the fifth information.

According to an embodiment, when second information indicates that a first layer and a second layer are encoded by using different methods, the scalable video decoding apparatus 14 may obtain, from a bitstream, fourth information indicating that the second layer does not refer to scaling list data on a sequence parameter set of the first layer. When the fourth information (for example, sps_infer_scaling_list_flag) that is information about reference of syntax with respect to scaling list data indicates that the scaling list data is not referred to (for example, when the fourth information has a value of 0), the scalable video decoding apparatus 14 may not refer to a syntax structure about the scaling list data based on the fourth information.

Also, according to another embodiment, when the obtained second information indicates that the first and second layers are encoded by using different methods, the scalable video decoding apparatus 14 may obtain, from a bitstream, fifth information indicating that the second layer does not refer to scaling list data on a picture parameter set of the first layer. When the fifth information (for example, pps_infer_scaling_list_flag) is information about reference of syntax with reference to scaling list data indicates that the scaling list data is not referred to (for example, when the fifth information has a value of 0), the scalable video decoding apparatus 14 may not refer to a syntax structure about the scaling list data based on the fifth information.

According to an embodiment, a scaling list data referring process may correspond to a process of referring to data required for a scaling process for adjusting a motion vector according to a characteristic difference between layers when inter-layer motion prediction is performed between the first and second layers. According to an embodiment, the scalable video encoding apparatus 10 or the scalable video decoding apparatus 14 may efficiently manage a bitstream by not referring to scaling list data based on the fourth or fifth information when it is difficult to perform inter-layer motion prediction because the first and second layers are encoded or decoded by using different encoding or decoding methods.

FIG. 2C illustrates processes of processing information about a maximum value of a temporal identifier for determining a picture of a referable layer between layers of a scalable video, according to an embodiment.

According to an embodiment, the scalable video encoding apparatus 10 may generate a bitstream including second information about whether a base layer and an enhancement layer, which form a scalable video, use the same encoding method. When the second information indicates that the base layer and the enhancement layer do not use the same encoding method, the scalable video encoding apparatus 10 may generate a bitstream including sixth information about a maximum value of a temporal identifier of a second picture to which a third picture refers, wherein the third picture is a picture included in a third layer. According to an embodiment, the third layer is one of a plurality of layers forming the scalable video and may correspond to an upper layer of the second layer.

Referring to FIG. 2C, the scalable video encoding apparatus 10 may generate a bitstream including a flag (for example, max_tid_ref_present_flag) about whether the sixth information about the maximum value of the temporal identifier of the second picture to which the third picture refers exists on a bitstream in a VPS extension of the scalable video to be encoded. The scalable video encoding apparatus 10 may perform a conditional statement 23 of determining whether the sixth information (for example, max_tid_il_ref_pics_plus1[i][j]) exists based on the generated flag. When it is determined that the sixth information exists based on the generated flag, the scalable video encoding apparatus 10 may perform a for-loop 24 with respect to an i-th layer that is a layer being referred to, and a for-loop 25 with respect to a j-th layer that is a layer being referred to. However, when a first layer and a second layer are encoded by using different encoding methods, inter-layer prediction may not be provided or may be performed in a manner different from a second picture in a method of encoding a first picture of a first layer that is the base layer to which the second picture included in a second layer refers. At this time, the scalable video encoding apparatus 10 may not generate the bitstream including the sixth information so as not to refer to the first picture while performing inter-layer prediction during a process of encoding the second picture. Accordingly, the for-loop 24 for the i-th layer may start from an upper layer of the first layer, instead of the first layer.

According to an embodiment, the for-loop 24 for the i-th layer may start from the second layer having a layer identifier higher than the first layer by 1. The scalable video encoding apparatus 10 according to an embodiment may generate information about whether the third layer referable so as to encode the second picture included in the second layer is directly dependent on the second layer.

According to an embodiment, the information about whether the third layer is directly dependent on the second layer may correspond to the second information. When it is determined that the third layer is directly dependent on the second layer to refer to the second layer based on the generated second information, the scalable video encoding apparatus 10 may generate a bitstream including the sixth information about the maximum value of the temporal identifier of the third picture of the third layer referable by the second layer.

According to an embodiment, the scalable video encoding apparatus 10 may encode the third picture included in the third layer by only referring to picture having a value of a temporal identifier equal to or lower than the maximum value from among pictures of the second layer referable while encoding the third layer, based on the sixth information.

According to an embodiment, the scalable video encoding apparatus 10 may generate a bitstream including the second information about whether the base layer and the enhancement layer, which form the scalable video, use the same encoding method. When the second information indicates that the base layer and the enhancement layer do not use the same encoding method, the scalable video encoding apparatus 10 may determine a maximum value of a temporal identifier of the first picture referable while the second picture performs inter-layer prediction between layers to be a pre-determined value of a temporal identifier. For example, when the second information indicates that the base layer and the enhancement layer do not use the same encoding method, the scalable video encoding apparatus 10 may refer to pictures, in which a value of a temporal identifier is lower than 7, from among the first pictures of the first layer while performing inter-layer prediction of the second layer. In other words, instead of generating a bitstream including the sixth information about the maximum value of the temporal identifier to be referred to while performing inter-layer prediction between the first and second layers that are encoded by using different encoding methods, the maximum value of the temporal identifier may be determined to be a pre-determined value and the second picture of the second layer may be encoded by using the pre-determined value.

According to an embodiment, the scalable video decoding apparatus 14 may obtain, from a bitstream, second information about whether a base layer and an enhancement layer, which form a scalable video, use the same encoding method. When the second information indicates that the base layer and the enhancement layer do not use the same encoding method, the scalable video decoding apparatus 14 may obtain, from a bitstream, sixth information about a maximum value of a temporal identifier of a second picture to which a third picture refers, wherein the third picture is a picture included in a third layer. According to an embodiment, the third layer is one of a plurality of layers forming the scalable video and may correspond to an upper layer of the second layer.

Referring to FIG. 2C, the scalable video dncoding apparatus 14 may obtain, from a bitstream, a flag (for example, max_tid_ref_present_flag) about whether the sixth information about the maximum value of the temporal identifier of the second picture to which the third picture refers exists on a bitstream in a VPS extension of the scalable video to be decoded. The scalable video decoding apparatus 14 may perform the conditional statement 23 of determining whether the sixth information (for example, max_tid_il_ref_pics_plus1[i][j]) exists based on the obtained flag. When it is determined that the sixth information exists based on the obtained flag, the scalable video decoding apparatus 14 may perform the for-loop 24 with respect to an i-th layer that is a layer being referred to, and the for-loop 25 with respect to a j-th layer that is a layer being referred to. However, when a first layer and a second layer are decoded by using different decoding methods, inter-layer prediction may not be provided or may be performed in a manner different from a second picture in a method of decoding a first picture of a first layer that is the base layer to which the second picture included in a second layer refers. At this time, the scalable video decoding apparatus 14 may not obtain the sixth information so as not to refer to the first picture while performing inter-layer prediction during a process of decoding the second picture. Accordingly, the for-loop 24 for the i-th layer may start from an upper layer of the first layer, instead of the first layer.

According to an embodiment, the for-loop 24 for the i-th layer may start from the second layer having a layer identifier higher than the first layer by 1. The scalable video decoding apparatus 14 according to an embodiment may obtain, from a bitstream, information about whether the third layer referable so as to encode the second picture included in the second layer is directly dependent on the second layer.

According to an embodiment, the information about whether the third layer is directly dependent on the second layer may correspond to the second information. When it is determined that the third layer is directly dependent on the second layer to refer to the second layer based on the generated second information, the scalable video decoding apparatus 14 may obtain, from a bitstream, the sixth information about the maximum value of the temporal identifier of the third picture of the third layer referable by the second layer.

According to an embodiment, the scalable video decoding apparatus 14 may decode the third picture included in the third layer by only referring to picture having a value of a temporal identifier equal to or lower than the maximum value from among pictures of the second layer referable while decoding the third layer, based on the sixth information.

According to an embodiment, the scalable video decoding apparatus 14 may obtain, from a bitstream, the second information about whether the base layer and the enhancement layer, which form the scalable video, use the same decoding method. When the second information indicates that the base layer and the enhancement layer do not use the same decoding method, the scalable video decoding apparatus 14 may determine a maximum value of a temporal identifier of the first picture referable while the second picture performs inter-layer prediction between layers to be a pre-determined value of a temporal identifier. For example, when the second information indicates that the base layer and the enhancement layer do not use the same decoding method, the scalable video decoding apparatus 14 may refer to pictures, in which a value of a temporal identifier is lower than 7, from among the first pictures of the first layer while performing inter-layer prediction of the second layer. In other words, instead of obtaining a bitstream including the sixth information about the maximum value of the temporal identifier to be referred to while performing inter-layer prediction between the first and second layers that are decoded by using different decoding methods, the maximum value of the temporal identifier may be determined to be a pre-determined value and the second picture of the second layer may be decoded by using the pre-determined value.

According to an embodiment, the scalable video encoding apparatus 10 may generate a bitstream including second information about whether a base layer and an enhancement layer, which form a scalable video, use the same encoding method. When the second information indicates that the base layer and the enhancement layer do not use the same encoding method, a sub-decoded picture buffer of a first layer that is the base layer may be set to an empty state after decoding of a picture included in a second layer is finished. According to a general encoding process, a sub-decoding picture buffer of a base layer is set to an empty state after a decoding process of a plurality of layers forming a scalable video is finished. However, it may be inefficient to store the sub-decoding picture buffer of the base layer until decoding of layers that do not refer to the base layer, form among the plurality of layers, is finished.

Thus, according to an embodiment, the scalable video encoding apparatus 10 may set the sub-decoding picture buffer of the base layer to an empty state after encoding of all layers referring to the base layer is finished. For example, when a layer referring to the first layer that is the base layer, from among the plurality of layers forming the scalable video, is a second layer, the sub-decoding picture buffer of the first layer may set to an empty state even before an encoding process of another layer excluding the first and second layers is finished, if encoding of the second layer is finished.

According to an embodiment, the scalable video decoding apparatus 14 may obtain, from a bitstream, second information about whether a base layer and an enhancement layer, which form a scalable video, use the same decoding method. When the second information indicates that the base layer and the enhancement layer do not use the same decoding method, a sub-decoded picture buffer of a first layer that is the base layer may be set to an empty state after decoding of a picture included in a second layer is finished. According to a general decoding process, a sub-decoding picture buffer of a base layer is set to an empty state after a decoding process of a plurality of layers forming a scalable video is finished. However, it may be inefficient to store the sub-decoding picture buffer of the base layer until decoding of layers that do not refer to the base layer, form among the plurality of layers, is finished.

Thus, according to an embodiment, the scalable video decoding apparatus 14 may set the sub-decoding picture buffer of the base layer to an empty state after decoding of all layers referring to the base layer is finished. For example, when a layer referring to the first layer that is the base layer, from among the plurality of layers forming the scalable video, is a second layer, the sub-decoding picture buffer of the first layer may set to an empty state even before a decoding process of another layer excluding the first and second layers is finished, if decoding of the second layer is finished.

The scalable video encoding apparatus 10 according to an embodiment may generate a bitstream including second information about whether a base layer and an enhancement layer, which form a scalable video, use the same encoding method. When the second information indicates that the base layer and the enhancement layer do not use the same encoding method, a bitstream including eighth information indicating a maximum value of a layer identifier allowed in a CVS referring to a VPS of the scalable video may be generated. According to an embodiment, the maximum number of layers allowed in the CVS referring to the VPS may be higher than 1. When the second information indicates that a first layer and a second layer, which form the scalable video, are encoded by using different methods, the number of layers forming a video to be encoded is more than 1. Considering that there is a plurality of types of layer identifiers of pictures included in an access unit based on the second information, the scalable video encoding apparatus 10 may determine whether the number of layers of a current scalable video, in which a base layer and an enhancement layer do not use the same encoding method, is more than 1, based on the second information and the eighth information. When the second information indicates that the first and second layers are encoded by using different methods while the eighth information indicates that the maximum number of layers allowed in the CVS referring to the VPS is not higher than 1, it may be determined that an error is generated during encoding or decoding processes.

The scalable video decoding apparatus 14 according to an embodiment may generate a bitstream including second information about whether a base layer and an enhancement layer, which form a scalable video, use the same decoding method. When the second information indicates that the base layer and the enhancement layer do not use the same decoding method, a bitstream including eighth information indicating a maximum value of a layer identifier allowed in a CVS referring to a VPS of the scalable video may be generated. According to an embodiment, the maximum number of layers allowed in the CVS referring to the VPS may be higher than 1. When the second information indicates that a first layer and a second layer, which form the scalable video, are decoded by using different methods, the number of layers forming a video to be decoded is more than 1. Considering that there is a plurality of types of layer identifiers of pictures included in an access unit based on the second information, the scalable video decoding apparatus 14 may determine whether the number of layers of a current scalable video, in which a base layer and an enhancement layer do not use the same decoding method, is more than 1, based on the second information and the eighth information. When the second information indicates that the first and second layers are decoded by using different methods while the eighth information indicates that the maximum number of layers allowed in the CVS referring to the VPS is not higher than 1, it may be determined that an error is generated during encoding or decoding processes.

The scalable video encoding apparatus 10 according to an embodiment may generate a bitstream including second information about whether a base layer and an enhancement layer, which form a scalable video, use the same encoding method. When the second information indicates that the base layer and the enhancement layer do not use the same encoding method, the scalable video encoding apparatus 10 may generate a bitstream including ninth information about whether a limitation that data units of all video encoding layers included in an access unit of the scalable video have same layer identifier or a limitation that a data unit of a video encoding layer of an access unit of the scalable video includes an intra random access point (IRAP) picture is applied, wherein the ninth information indicates that the limitation is not always applied. When a random access point of a bitstream is generated by the scalable video encoding apparatus 10, the scalable video decoding apparatus 14 may perform decoding from the generated random access point. A base layer included in an access unit of a random access point is encoded to an RAP picture, and upper layers may be encoded to non-IRAP pictures or RAP pictures. An access unit is a group of NAL units or pictures simultaneously displayable.

According to an embodiment, a non-VCL NAL unit may be an NAL unit including RBSP that transmits, as information required to encode or decode a video, information that is not about actual video data (for example, a VPS, a sequence parameter set, or a picture parameter set). On the other hand, a VCL NAL unit may be an NAL unit including video data, such as RBSP of an actual encoded slice segment.

When a first layer that is the base layer and a second layer that is an enhancement layer are encoded by using the same method, and the ninth information has a value of 1, a limitation that all VCL NAL units of one access unit have the same layer identifier (for example, nuh_layer_id) or a limitation that VCL NAL units of one access unit have two types of layer identifier and a picture having a higher layer identifier corresponds to an RAP picture may be applied. However, when the first and second layers are encoded by using different methods, the ninth information may indicate that such a limitation is not applied. For example, when the first and second layers are encoded by using different methods, the ninth information may have a value of 0, but an embodiment is not limited thereto. Since a scalable video may include a plurality of layers, considering that there is a plurality of types of a layer identifier of pictures included in an access unit, when second information indicates that a base layer and an enhancement layer do not use the same encoding method, ninth information is not used so as to efficiently manage a bitstream.

According to an embodiment, the scalable video encoding apparatus 10 may generate a bitstream including second information indicating whether a base layer and an enhancement layer, which form a scalable video, use the same encoding method. When the second information indicates that the base layer and the enhancement layer do not use the same encoding method, a bitstream including ninth information indicating whether a limitation is applied on the RAP picture may be generated. In addition, when the ninth information indicates that a limitation that data units of all video encoding layers included in an access unit of the scalable video have the same layer identifier or a limitation that a data unit of a video encoding layer of an access unit of the scalable video includes an RAP picture is not always applied, the scalable video encoding apparatus 10 may generate a bitstream including tenth information.

According to an embodiment, when the ninth information indicates that the limitation that data units of all video encoding layers included in an access unit of a scalable video have the same layer identifier or the limitation that a data unit of a video encoding layer of an access unit of a scalable video includes an IRAP picture is applied, the tenth information may indicate that pictures of two layers from among the plurality of layers forming the scalable video are in one access unit and that an RAP picture that is a picture of an upper layer is encoded via inter-layer prediction process referring to a picture of a lower layer.

The scalable video decoding apparatus 14 according to an embodiment may generate a bitstream including second information about whether a base layer and an enhancement layer, which form a scalable video, use the same decoding method. When the second information indicates that the base layer and the enhancement layer do not use the same decoding method, the scalable video decoding apparatus 14 may generate a bitstream including ninth information about whether a limitation that data units of all video encoding layers included in an access unit of the scalable video have same layer identifier or a limitation that a data unit of a video encoding layer of an access unit of the scalable video includes an RAP picture is applied, wherein the ninth information indicates that the limitation is not always applied. When a random access point of a bitstream is generated by the scalable video decoding apparatus 14, the scalable video decoding apparatus 14 may perform decoding from the generated random access point. A base layer included in an access unit of a random access point is decoded to an RAP picture, and upper layers may be decoded to non-IRAP pictures or RAP pictures. An access unit is a group of NAL units or pictures simultaneously displayable.

When a first layer that is the base layer and a second layer that is an enhancement layer are decoded by using the same method, and the ninth information has a value of 1, a limitation that all VCL NAL units of one access unit have the same layer identifier (for example, nuh_layer_id) or a limitation that VCL NAL units of one access unit have two types of layer identifier and a picture having a higher layer identifier corresponds to an RAP picture may be applied. However, when the first and second layers are decoded by using different methods, the ninth information may indicate that such a limitation is not applied. For example, when the first and second layers are decoded by using different methods, the ninth information may have a value of 0, but an embodiment is not limited thereto. Since a scalable video may include a plurality of layers, considering that there is a plurality of types of a layer identifier of pictures included in an access unit, when second information indicates that a base layer and an enhancement layer do not use the same decoding method, ninth information is not used so as to efficiently manage a bitstream.

According to an embodiment, the scalable video encoding apparatus 10 may generate a bitstream including second information indicating whether a base layer and an enhancement layer, which form a scalable video, use the same decoding method. When the second information indicates that the base layer and the enhancement layer do not use the same decoding method, a bitstream including ninth information indicating whether a limitation is applied on the RAP picture may be generated. In addition, when the ninth information indicates that a limitation that data units of all video encoding layers included in an access unit of the scalable video have the same layer identifier or a limitation that a data unit of a video encoding layer of an access unit of the scalable video includes an RAP picture is not always applied, the scalable video decoding apparatus 14 may generate a bitstream including tenth information.

According to an embodiment, when the ninth information indicates that the limitation that data units of all video encoding layers included in an access unit of a scalable video have the same layer identifier or the limitation that a data unit of a video encoding layer of an access unit of a scalable video includes an IRAP picture is applied, the tenth information may indicate that pictures of two layers from among the plurality of layers forming the scalable video are in one access unit and that an RAP picture that is a picture of an upper layer is decoded via inter-layer prediction process referring to a picture of a lower layer.

FIG. 2D illustrates a part of syntax of video usability information about a VPS, according to an embodiment.

According to an embodiment, video usability information may denote information usable in decoder conformance or output timing conformance although not used during processes of decoding a luminance component and a chrominance component. An error may be generated during a decoding process when a scalable video is decoded without the video usability information about a VPS.

The scalable video encoding apparatus 10 according to an embodiment may determine whether the number of layers directly dependent on an i-th layer is 0 based on information (for example, NumDirectRefLayers[layer_id_in_nuh[i]]) about the number of layers directly dependent on the i-th layer. When the number of layers directly dependent on the i-th layer is 0, the scalable video encoding apparatus 10 according to an embodiment may generate a bitstream including seventh information indicating whether to apply a limitation of referring to a picture parameter set and a sequence parameter set of a first picture while determining a picture parameter set and a sequence parameter set of a second picture.

According to an embodiment, the scalable video encoding apparatus 10 may generate a bitstream including second information about whether a base layer and an enhancement layer, which form a scalable video, use the same encoding method. When the second information indicates that the base layer and the enhancement layer do not use the same decoding method and the number of layers directly dependent on the i-th layer is 0, the scalable video encoding apparatus 10 may generate a bitstream including seventh information indicating whether to apply a limitation of referring to the picture parameter set and the sequence parameter set of the first picture while determining the picture parameter set and the sequence parameter set of the second picture.

According to an embodiment, the seventh information may indicate that the limitation is not always applied. For example, when the number of layers directly dependent on the i-th layer to be encoded is 0, the scalable video encoding apparatus may generate a bitstream such that a value of base_layer_parameter_set_compatibility_flag[i], i.e., the seventh layer, is 0. According to base_layer_parameter_set_compatibility_flag[i] having a value of 0, a limitation that a picture parameter set and a sequence parameter set of a base layer is to be referred to in relation to the i-th layer may not be applied during an encoding process of a slice segment NAL unit referring to a VPS.

The scalable video decoding apparatus 14 according to an embodiment may determine whether the number of layers directly dependent on an i-th layer is 0 based on information (for example, NumDirectRefLayers[layer_id_in_nuh[i]]) about the number of layers directly dependent on the i-th layer. When the number of layers directly dependent on the i-th layer is 0, the scalable video decoding apparatus 14 according to an embodiment may obtain, from a bitstream, seventh information indicating whether to apply a limitation of referring to a picture parameter set and a sequence parameter set of a first picture while determining a picture parameter set and a sequence parameter set of a second picture.

According to an embodiment, the scalable video decoding apparatus 14 may obtain, from a bitstream, second information about whether a base layer and an enhancement layer, which form a scalable video, use the same encoding method. When the second information indicates that the base layer and the enhancement layer do not use the same decoding method and the number of layers directly dependent on the i-th layer is 0, the scalable video decoding apparatus 14 may obtain, from a bitstream, seventh information indicating whether to apply a limitation of referring to the picture parameter set and the sequence parameter set of the first picture while determining the picture parameter set and the sequence parameter set of the second picture.

According to an embodiment, the seventh information may indicate that the limitation is not always applied. For example, when the number of layers directly dependent on the i-th layer to be encoded is 0, the scalable video decoding apparatus may generate a bitstream such that a value of base_layer_parameter_set_compatibility_flag[i], i.e., the seventh layer, is 0. According to base_layer_parameter_set_compatibility_flag[i] having a value of 0, a limitation that a picture parameter set and a sequence parameter set of a base layer is to be referred to in relation to the i-th layer may not be applied during a decoding process of a slice segment NAL unit referring to a VPS.

Details described above with reference to the scalable video encoding apparatus 10 and the scalable video decoding apparatus 14 are details corresponding to a method of encoding or decoding a scalable video in terms of an apparatus, and thus the method of encoding or decoding a scalable video may be performed based on above features.

FIG. 3A illustrates a scalable video 30 including a plurality of layers, according to an embodiment. The scalable video 30 may include at least one video sequences, i.e., video sequences 21 through 23 having different scalable extension types.

In order to provide an optimal service in various network environments and various terminals, the scalable video encoding apparatus 10 may output a scalable bitstream by encoding scalable video sequences having various spatial resolutions, various qualities, various frame-rates, and different views. That is, the scalable video encoding apparatus 10 may generate a video bitstream by encoding an input image according to various scalability types and may output the video bitstream. Scalability includes temporal scalability, spatial scalability, quality scalability, multiview scalability, and combinations thereof. The scalabilities may be classified according to types. Also, the scalabilities may be identified as dimension identifiers in the types.

For example, scalability has scalability types including temporal scalability, spatial scalability, quality scalability, multiview scalability, or the like. According to the types, the scalabilities may be identified as dimension identifiers. For example, when they have different scalabilities, they may have different dimension identifiers. For example, when a scalability type corresponds to high-dimensional scalability, a higher scalability dimension may be assigned thereto.

When a bitstream is dividable into valid substreams, the bitstream is scalable. A spatially scalable bitstream includes substreams having various resolutions. In order to distinguish between different scalabilities in a same scalability type, a scalability dimension is used. The scalability dimension may be referred to as a scalability dimension identifier.

According to an embodiment, a temporally-scalable bitstream may include substreams having various frame-rates. For example, the temporally-scalable bitstream may be divided into substreams that respectively have a frame-rate of 7.5 Hz, a frame-rate of 15 Hz, a frame-rate of 30 Hz, and a frame-rate of 60 Hz. According to an embodiment, a quality-scalable bitstream may be divided into substreams having different qualities according to a Coarse-Grained Scalability (CGS) technique, a Medium-Grained Scalability (MGS) technique, and a Fine-Grained Scalability (FGS) technique. The temporally-scalable bitstream may also be divided into different dimensions according to different frame-rates, and the quality-scalable bitstream may also be divided into different dimensions according to the different techniques.

According to an embodiment, the spatially-scalable bitstream may be divided into substreams having different resolutions such as a quarter video graphics array (QVGA), a video graphics array (VGA), a wide video graphics array (WVGA), or the like. For example, layers respectively having different resolutions may be distinguished therebetween by using dimension identifiers. For example, a QVGA substream may have 0 as a value of a spatial scalability dimension identifier, a VGA substream may have 1 as a value of the spatial scalability dimension identifier, and a WVGA substream may have 2 as a value of the spatial scalability dimension identifier.

According to an embodiment, a multiview scalable bitstream may include substreams having different views in one bitstream. According to an embodiment, a bitstream of a stereoscopic video includes a left-view image and a right-view image. Also, a scalable bitstream may include substreams with respect to encoded data of a multiview image and a depth map. View-scalability may be divided into different dimensions according to views.

When the scalable video 30 according to an embodiment may is a multiview video, a video sequence 31 of a first layer that is a base layer may include pictures of a first viewpoint. Here, first view videos may include a first picture 34. Like the first layer, a video sequence 32 of a second layer that is an enhancement layer may include pictures of a second viewpoint. Here, the second view videos may include a second picture 35. In addition, when there are at least three enhancement layers, base layer images and first through n-th enhancement layer images may be encoded. Accordingly, an encoding result of the base layer images may be output as a base layer stream, and encoding results of the first through n-th enhancement layer images may be respectively output as first through n-th enhancement layer streams. A video sequence 33 of such an n-th layer may include pictures of an n-th viewpoint. As another embodiment, the video sequence 31 of the first layer may be a left-view video of the base layer, the video sequence 32 of the second layer may be a right-view video of the base layer, and the video sequence 33 of the n-th layer may be a right-view video of the enhancement layer. However, an embodiment is not limited thereto, and the video sequences 21 through 23 having different scalable extension types may each include pictures having different attributes.

The scalable video decoding apparatus 14 according to various embodiment may perform inter prediction for predicting a current image by referring to images in the same layer. Through the inter prediction, a motion vector representing motion information between the current image and a reference image, and a residual between the current image and the reference image may be generated.

Also, the scalable decoding apparatus 14 according to various embodiments may perform inter-layer prediction for predicting enhancement layer images by referring to base layer images. The scalable video decoding apparatus 14 may perform inter-layer prediction for predicting second enhancement layer images by referring to first enhancement layer images. Through the inter-layer prediction, a position difference component between a current image and a reference image of a layer different from that of the current image and a residual between the current image and the reference image of the different layer may be generated.

When the scalable video decoding apparatus 14 according to an embodiment allows at least two enhancement layers, inter-layer prediction may be performed between one base layer image and the at least two enhancement layer images according to a prediction structure between a plurality of layers. An inter-layer prediction system performable in the base layer and the enhancement layer will be described in detail below with reference to FIG. 3B.

Different scalable extension types may be combined with each other. That is, a scalable video bitstream may include substreams obtained by encoding video sequences of a plurality of layers including images where one or more of temporal, spatial, quality, and multiview scalabilities are different therebetween. According to an embodiment, the video sequence 31 of the first layer, the video sequence 32 of the second layer, and the video sequence 33 of the n-th layer (n is an integer) may be video sequences where at least one of resolution, quality, and viewpoint is different. Also, one of the video sequence 31 of the first layer, the video sequence 32 of the second layer, and the video sequence 33 of the n-th layer (n is an integer) may be a video sequence of a base layer, and the remaining video sequences may be video sequences of an enhancement layer.

FIG. 3B illustrates a scalable video encoding system 16000 according to an embodiment.

A scalable video encoding system 16000 includes a base layer encoding terminal 16100, an enhancement layer encoding terminal 16600, and an inter-layer prediction terminal 16500 between the base layer encoding terminal 16100 and the enhancement layer encoding terminal 16600.

The base layer encoding terminal 16100 receives an input of a base layer video sequence and encodes each image. The enhancement layer encoding terminal 16600 receives an input of an enhancement layer video sequence and encodes each image. Operations that overlap in operations of the base layer encoding terminal 16100 and operations of the enhancement layer encoding terminal 16600 are simultaneously described below.

A block splitter 16180 or 16680 splits an input image (a low-resolution image or a high-resolution image) to a largest coding unit, a coding unit, a prediction unit, a transformation unit, etc. In order to encode the coding unit that is output from the block splitter 16180 or 16680, intra prediction or inter prediction may be performed with respect to each prediction unit of the coding unit. A prediction switch 16480 or 16980 may perform the inter prediction by referring to a reconstructed previous image output from a motion compensator 16400 or 16900 or may perform the intra prediction by using a neighbouring prediction unit of a current prediction unit in a current input image output from an intra predictor 16450 or 16950, based on whether a prediction mode of the prediction unit is an intra prediction mode or an inter prediction mode. Residue information may be generated with respect to each prediction unit due to the inter prediction.

A residue component between the prediction unit and a neighbouring image is input to a transformer/quantizer 16200 or 16700, according to each prediction unit of the coding unit. The transformer/quantizer 16200 or 16700 may perform transformation and quantization with respect to each transformation unit, based on the transformation unit of the coding unit, and may output a quantized transformation coefficient.

A scaling/inverse transformer 16250 or 16750 may perform scaling and inverse-transformation on the quantized transformation coefficient, according to each transformation unit of the coding unit, and may generate a residue component of a spatial domain. When it is controlled to an inter mode due to the prediction switch 16480 or 16980, the residue component may be synthesized with the reconstructed previous image or the neighbouring prediction unit, so that a reconstructed image including the current prediction unit may be generated and a reconstructed current image may be stored in a storage 16300 or 16800. The reconstructed current image may be transferred to the intra predictor 16450 or 16950/the motion compensator 16400 or 16900, according to a prediction mode of a prediction unit to be next encoded.

In particular, during the inter mode, an in-loop filter 16350 or 16850 may perform at least one of deblocking filtering and Sample Adaptive Offset (SAO) filtering on the reconstructed image stored in the storage 16300 or 16800, according to each coding unit. At least one of the deblocking filtering and the SAO filtering to compensate for an encoding error between an original image and a reconstructed image may be performed on the coding unit. At least one of the deblocking filtering and the SAO filtering may be performed on the coding unit and at least one of a prediction unit and a transformation unit included in the coding unit.

The deblocking filtering is filtering for smoothing a blocking phenomenon of a data unit, and the SAO filtering is filtering for compensating for a pixel value that has been corrupted while data is encoded and decoded. Data that is filtered by the in-loop filter 16350 or 16850 may be transferred to the motion compensator 16400 or 16900, according to each prediction unit. In order to encode a next coding unit output from the block splitter 16180 or 16680, a residue component between the reconstructed current image and the next coding unit may be generated, wherein the reconstructed current image is output from the motion compensator 16400 or 16900 and the next coding unit is output from the block splitter 16180 or 16680.

In this manner, the aforementioned encoding procedure may be repeated with respect to each coding unit of the input image.

Also, for inter-layer prediction, the enhancement layer encoding terminal 16600 may refer to the reconstructed image stored in the storage 16300 of the base layer encoding terminal 16100. An encoding controller 16150 of the base layer encoding terminal 16100 may control the storage 16300 of the base layer encoding terminal 16100, and may transfer the reconstructed image of the base layer encoding terminal 16100 to the enhancement layer encoding terminal 16600. The transferred reconstructed base layer image may be used as a prediction image of the enhancement layer.

When the base layer and the enhancement layer have different resolutions, an in-loop filter 16550 of the inter-layer prediction terminal 16500 may upsample the reconstructed base layer image and may transfer an upsampled reconstructed base layer image to the enhancement layer encoding terminal 16600. Therefore, the upsampled reconstructed base layer image may be used as the prediction image of the enhancement layer.

When the inter-layer prediction is performed in a manner that an encoding controller 16650 of the enhancement layer encoding terminal 16600 controls the switch 16980, the enhancement layer image may be predicted by referring to the reconstructed base layer image that is transferred via the inter-layer prediction terminal 16500.

In order to encode an image, various encoding modes for a coding unit, a prediction unit, and a transformation unit may be set. For example, as an encoding mode for the coding unit, a depth, split information (e.g., a split flag), or the like may be set. As an encoding mode for the prediction unit, a prediction mode, a partition type, intra direction information, reference list information, or the like may be set. As an encoding mode for the prediction unit, a transformation depth, split information or the like may be set.

The base layer encoding terminal 16100 may perform encoding by using each of various depths for the coding unit, each of various modes for the prediction unit, each of various partition types, each of various intra directions, each of various reference lists, and each of various transformation depths for the transformation unit, and according to results of the performances, the base layer encoding terminal 16100 may determine an encoding depth, a prediction mode, a partition type, intra direction/reference list, a transformation depth, etc. that have the highest encoding efficiency. However, an encoding mode determined by the base layer encoding terminal 16100 is not limited to the aforementioned encoding modes.

The encoding controller 16150 of the base layer encoding terminal 16100 may control various encoding modes to be appropriately applied to operations of each configuring element. Also, for inter-layer encoding in the enhancement layer encoding terminal 16600, the encoding controller 16150 may control the enhancement layer encoding terminal 16600 to determine an encoding mode or a residue component by referring to the encoding results from the base layer encoding terminal 16100.

For example, the enhancement layer encoding terminal 16600 may use an encoding mode of the base layer encoding terminal 16100 as an encoding mode for the enhancement layer image, or may determine the encoding mode for the enhancement layer image by referring to an encoding mode of the base layer encoding terminal 16100. The encoding controller 16150 of the base layer encoding terminal 16100 may use a current encoding mode from the encoding mode of the base layer encoding terminal 16100 so as to determine a current encoding mode of the enhancement layer encoding terminal 16600 by controlling a control signal of the encoding controller 16650 of the enhancement layer encoding terminal 16600.

In particular, the enhancement layer encoding terminal 16600 according to an embodiment may encode an inter-layer prediction error by using an SAO parameter. Thus, a prediction error between a predicted enhancement layer image determined from the reconstructed base layer image and a reconstructed enhancement layer image may be encoded as an offset of the SAO parameter.

Similar to the multilayer encoding system 16000 shown in FIG. 3B, a multilayer decoding system based on the inter-layer prediction technique may be embodied. That is, the multilayer decoding system may receive a base layer bitstream and an enhancement layer bitstream. A base layer decoding terminal of the multilayer decoding system may reconstruct base layer images by decoding the base layer bitstream. An enhancement layer decoding terminal of the multilayer decoding system may decode the enhancement layer bitstream by using a reconstructed base layer image and parsed encoding information and may reconstruct enhancement layer images. The scalable video decoding apparatus 14 according to an embodiment may include such a multilayer decoding system.

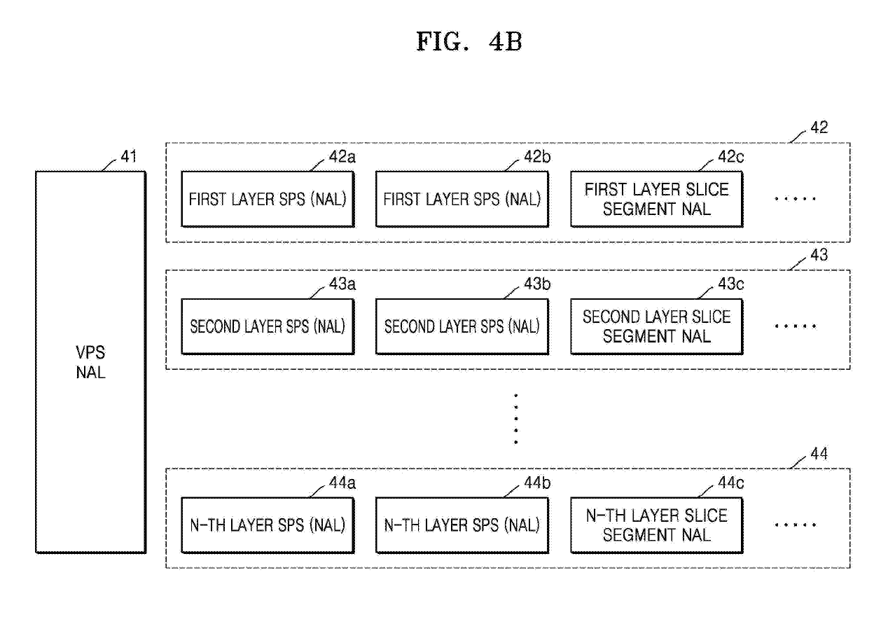

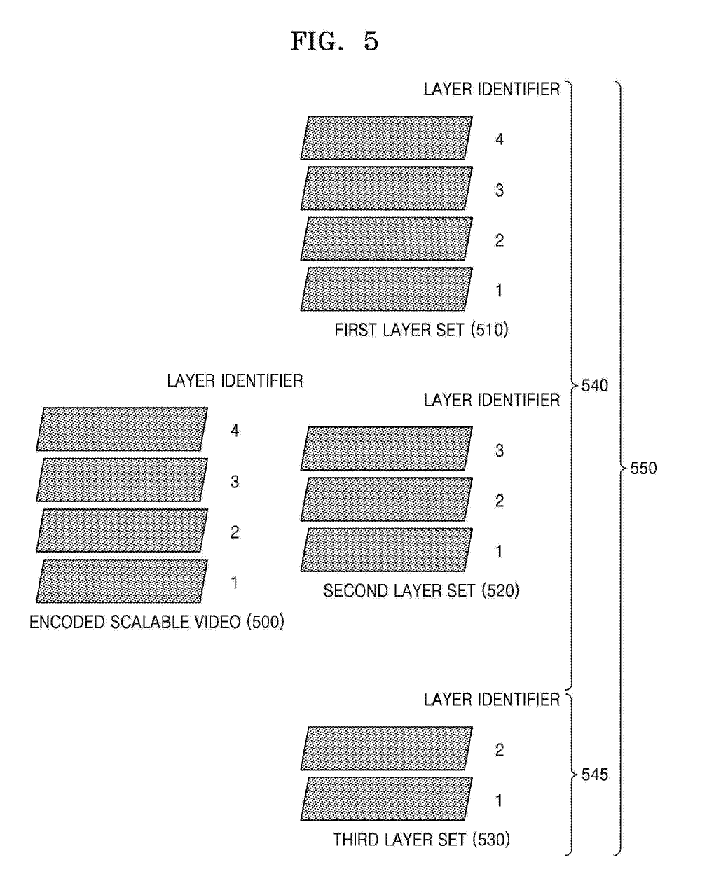

FIG. 4A is a diagram of an NAL unit header according to an embodiment.

Referring to FIG. 4A, an NAL unit header has a length of total 2 bytes. The NAL unit header includes forbidden_zero_bit (F) 31 having a value of 0 as a bit for identifying an NAL unit, an identifier 32 indicating a type of the NAL unit (nal unit type, hereinafter, referred to as NUT), a layer identifier 33 for distinguishing a layer to which the NAL unit belongs, and a temporal identifier (ID) 34 of the NAL unit. The layer identifier 33 for distinguishing the layer to which the NAL unit belongs may have a value of 0 when a video includes a single layer, but when a video includes a plurality of layers, such as a scalable video, a value of the layer identifier 33 of the plurality of layers forming the scalable video may have a value equal to or higher than 0. According to an embodiment, a value of the layer identifier 33 of a base layer from among the plurality of layers forming the scalable video may be 0, and a value of the layer identifier 33 of an enhancement layer may be at least 1. The scalable video decoding apparatus 14 according to an embodiment may reproduce video content by decoding a scalable video by using a plurality of layers including a base layer.

FIG. 4B illustrates NAL units including encoded data of a scalable video, according to an embodiment.

The scalable video decoding apparatus 14 may obtain, from a bitstream, NAL units including encoded scalable video data and auxiliary information. A VPS may include information to be applied to scalable video sequences 42, 43, and 44 included in the multilayer video. A NAL unit including information about the VPS is referred to as a VPS NAL unit 41.

The VPS NAL unit 41 includes a common syntax element shared by the video sequences 42, 43, and 44 forming a scalable video, information about an operation point to prevent transmission of unnecessary information, required information about an operation point which is required in a session negotiation step such as a profile or a level, or the like. According to an embodiment, scalability realized in a scalable video may be identified by a scalability identifier, and the VPS NAL unit 41 may include scalability information related to the scalability identifier. The scalability information is information for determining scalability to be applied to the scalable sequences 42, 43, and 44 included in the scalable video.

The scalability information includes information about a scalability type and a scalability dimension applied to the scalable video sequences 42 through 4 included in the scalable video. According to an embodiment, the scalability information may be directly obtained from a value of a layer identifier included in a NAL unit header. The layer identifier is an identifier for distinguishing a plurality of layers related to a VPS. The VPS may signal the layer identifier of each layer through VPS extension. The layer identifier of each layer of the VPS may be signaled by being included in the VPS NAL unit. For example, the layer identifier of the NAL units belong to a certain layer of the VPS may be included in the VPS NAL unit. For example, the layer identifier of the NAL unit belonging to the VPS may be signaled through the VPS extension. Accordingly, the scalable video decoding apparatus 14 according to an embodiment may use a VPS, and obtain scalability information about a layer of NAL units belonging to the VPS by using a layer identifier of the NAL units. Such a VPS may include a VPS identifier. Since the VPS is in a reference relationship with an SPS, the SPS referring to the VPS may include the VPS identifier for identifying the VPS to which the SPS refers.

A VPS NAL unit that is an NAL unit of a VPS about a scalable video including a plurality of layers may include a layer identifier in a header of the NAL unit, and a value of the layer identifier may be 0. For example, the layer identifier of the VPS NAL unit including a VPS identifier may be 0 when VPS raw byte sequence payload (RBSP), which is syntax obtained when information about the VPS is encapsulated to the NAL unit through byte alignment, is included in at least one access unit in which a value of a VPS temporal identifier (TemporallD) is 0 or is provided to an external decoding method that is not a currently used decoding method such that VPS RBSP reproduces a scalable video. However, according to an embodiment, the layer identifier of such a VPS NAL unit may have a value higher than 0 when a base layer of the scalable video includes a video sequence encoded by using the external decoding method. This will be described in detail below with reference to FIGS. 4A and 4B.

According to an embodiment, a layer identifier may be included not only in the VPS NAL unit 31, but also SPS NAL units 42a through 44a including sequence parapter set (SPS) information of each layer, and PPS NAL units 42b through 44b including picture parameter set (PPS) information of each layer.

An SPS includes information commonly applied to a video sequence of one layer. The SPS NAL units 42a through 44a including such an SPS may include information commonly applied respectively to the video sequences 42 through 44.

A PPS includes information commonly applied to pictures of one layer. The PPS NAL units 42b through 44b including such a PPS may each include information commonly applied to pictures of the same layer. The PPS may include information about an encoding mode of all pictures, for example, an entropy encoding mode, and a quantization parameter initialization value of a picture unit. The PPS does not need to be generated per picture. In other words, when a PPS does not exist, a previous PPS may be used, and when information included in the PPS needs to be updated, a new PPS may be set and a PPS NAL unit including information about the new PPS may be generated.

A slice segment includes encoding data of at least one largest coding unit, and such a slice segment may be included in the slice segment NAL units 42c through 44c to be transmitted.

As shown in FIG. 4B, one scalable video includes the scalable video sequences 42 through 44. In order to identify a sequence, an SPS of each layer may include an SPS identifier (sequence_parameter_set_id). By assigning an SPS identifier to a PPS, a sequence including the PPS may be identified. Also, a PPS may include a PPS identifier (picture_parameter_set_id), and a slice segment may refer to the PPS identifier included in the slice segment to identify which PPS is referred to by the slice segment. Also, information about an SPS and a layer used in a slice segment may be identified by using an SPS identifier indicated by a PPS identifier to which the slice segment refers. In other words, a PPS may refer to an SPS. For example, let's assume that an SPS identifier (sequence_parameter_set_id) of the first layer SPS NAL 42a has a value of 0. In this case, the first layer PPS NAL 42b included in the first layer video sequence 42 includes an SPS identifier (sequence_parameter_set_id) having a value of 0. Also, let's assume that a PPS identifier (picture_parameter_set_id) of the first layer PPS NAL 42b has a value of 0. In this case, the first layer slice segment NAL 42c referring to the first layer PPS NAL 42b includes a PPS identifier (picture_parameter_set_id) having a value of 0.

FIG. 4B illustrates an example of forming one VPS, but it is possible to form a scalable video shown in FIG. 4B to a plurality of scalable videos. In this case, a VPS identifier (video_paramter_set_id) may be included in an SPS NAL unit in order to identify a scalable video including NAL units from among the plurality of scalable videos. For example, when a VPS identifier (video_parameter_set_id) of the VPS NAL 31 has a value of 0, a VPS identifier (video_parameter_set_id) having a value of 0 may be included in the SPS NAL 42a through 44a included in one scalable video.

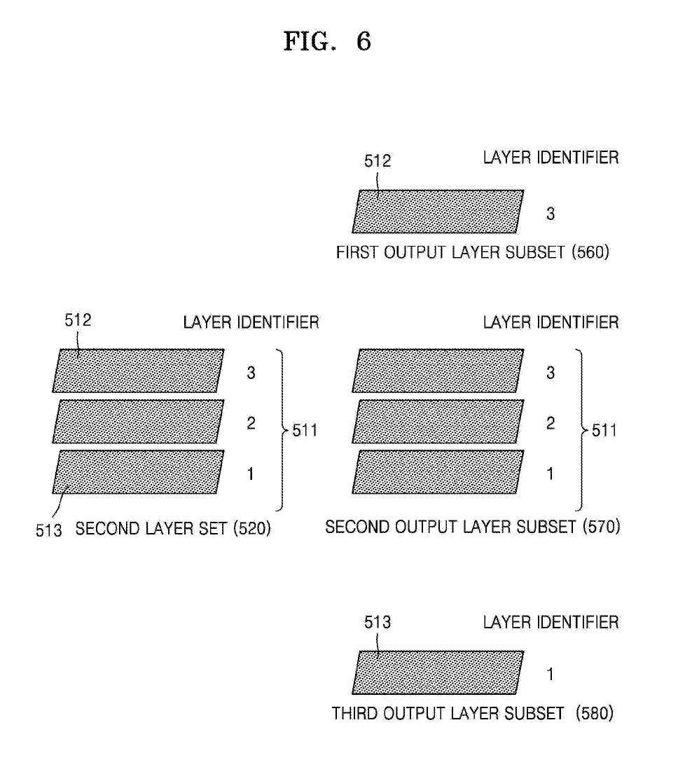

FIG. 5 is a diagram for describing a layer set according to various embodiments.

The scalable video encoding apparatus 10 may determine a layer set including one or more layers of a scalable video. Here, determined layer sets may be plural in number. In the present embodiment, a layer identifier may vary according to layers, and it is assumed that a layer having a minimum layer-identifier value is a base layer. Also, a layer having a great layer-identifier value may be an enhancement layer that is decoded by referring to other layers after the other layers are decoded.

It is assumed that an encoded scalable video 500 according to an embodiment includes four layers. The layers have layer identifiers that are different from each other. Here, the scalable video 500 may have three layer sets below. A first layer set 510 may include all layers included in the scalable video 500. A second layer set 520 may include three layers included in a scalable video. A layer set group 540 may include at least one layer set. For example, the layer set group 540 may include the first layer set 510 and the second layer set 520. Meanwhile, a third layer set 530 may include two layers included in the scalable video.

An additional layer set group 545 may include at least one additional layer set. According to an embodiment, the additional layer set may be defined to include a layer subtree of at least one enhancement layer excluding a base layer, wherein the layer subtree may denote a group of reference layers included in a subtree that is a group of layers in a reference relationship. According to an embodiment, when a base layer included in the scalable video 500 is encoded by using an encoding method different from other layers included in the scalable video 500, the number of additional layer group may be at least one. According to an embodiment, a layer of the additional layer group may include an independent non-base layer. For example, the additional layer set group 545 may include the third layer set 530 that is an additional layer set.

Meanwhile, an output layer set group 550 may include at least one layer set group. For example, the output layer set group 550 may include the layer set group 540 and the additional layer set group 545.

A layer set included in the output layer set group 550 is referred to as an output layer set. For example, the output layer set group 550 includes the first layer set 510, the second layer set 520, and the third layer set 530.

The scalable video decoding apparatus 14 may determine one output layer set from among the output layer set group 550. Such determined output layer set group is a target output layer set. The scalable video decoding apparatus 14 may decode layers included in the target output layer set, by using the determined target output layer set as a decoding target layer set.

The scalable video decoding apparatus 14 may determine layer sets by combining decodable layers.

Meanwhile, after the scalable video encoding apparatus 10 determines the output layer set group, the scalable video encoding apparatus 10 may generate information indicating the number of the output layer sets included in the output layer set group, and may generate a bitstream including the generated information that indicates the number of the output layer sets.

The scalable video decoding apparatus 14 may obtain the generated bitstream, may obtain, from the obtained bitstream, information indicating the number of the output layer sets, and may determine the output layer set group by using the obtained information.

The scalable video encoding apparatus 10 may determine a target output layer set from among the output layer set group, and may generate a bitstream including layers included in the determined target output layer set.

The scalable video decoding apparatus 14 may determine the output layer set group, based on the information of the bitstream which indicates the number of the output layer sets.

According to an embodiment, the scalable video decoding apparatus 14 may determine in advance, from among the determined output layer set group, the target output layer set to be decoded. For example, before the scalable video decoding apparatus 14 receives the bitstream, the scalable video decoding apparatus 14 may determine, from among the layer sets 510, 520, and 530, the first layer set 510 as the target output layer set to be decoded. However, it is not limited thereto, and when the scalable video encoding apparatus 10 determines the target output layer set from among the output layer set group, the scalable video encoding apparatus 10 generates an index indicating the target output layer set from among the output layer set group. The scalable video decoding apparatus 14 obtains the generated bitstream. The scalable video decoding apparatus 14 may obtain, from the obtained bitstream, the index indicating the target output layer set, may determine, by using the obtained index, the target output layer set from among the output layer set group, and may decode a layer included in the target output layer set.

The scalable video decoding apparatus 14 may determine the output layer set group, based on the information about the number of the output layer sets and the index, and when the scalable video decoding apparatus 14 determines the first layer set 510 that is the target output layer set from among the determined output layer set group, the scalable video decoding apparatus 14 may determine whether layers included in the bitstream have all of layers included in the first layer set 510. When the scalable video decoding apparatus 14 determines that the layers included in the first layer set 510 are all included, the scalable video decoding apparatus 14 may decode the layers included in the first layer set 510 and thus may reconstruct a video.

In more detail, the scalable video decoding apparatus 14 may determine the number of layer sets (NumLayerSets), based on a syntax element vps_num_layer_sets_minus1 indicating the number of layer sets obtained from a bitstream−1 and a syntax element num_add_layer_set indicating the number of additional layer sets. The number of output layer sets (NumOutputLayerSets) may be determined based on the number of layer sets (NumLayerSets) and an additional output layer set (num_add_olss) obtained from the bitstream.

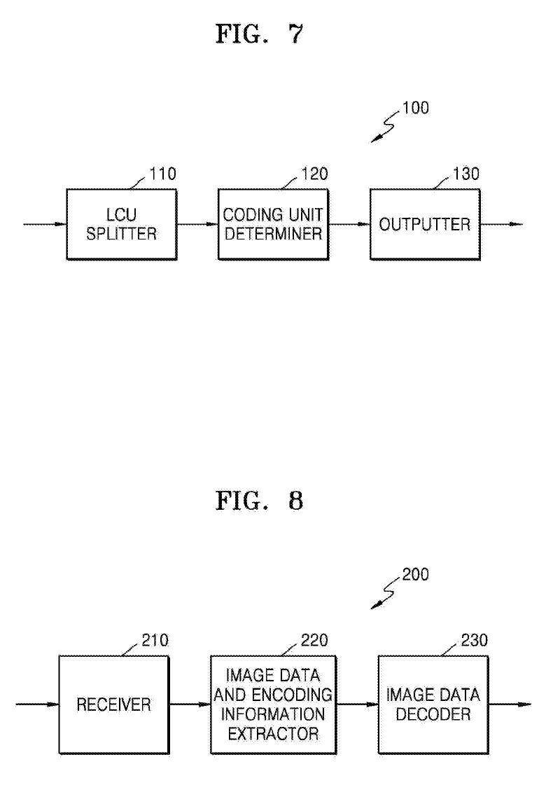

FIG. 6 is a diagram for describing an output layer subset, according to an embodiment.

Referring to FIG. 6, it is assumed that the scalable video decoding apparatus 14 determined the second layer set 520 of FIG. 5 as a target output layer set.

The scalable video decoding apparatus 14 decodes at least one of layers 511 included in the first layer set 510. However, the scalable video decoding apparatus 14 may not display all decoded layers but may display at least one layer from among the decoded layers.

The scalable video decoding apparatus 30 may determine an output target layer from among the layers included in the second layer set 520. In more detail, the scalable video decoding apparatus 30 may determine an output layer subset including the output target layer from among the layers included in the second layer set 520.

For example, a first output layer subset 560 according to an embodiment may include only a layer 512 that has a maximum layer-identifier value and is from among the layers included in the second layer set 520. In a case where a scalable video has a spatial scalability type, a layer having a minimum layer-identifier value is a low-resolution layer, and a highest layer is a high-resolution layer. The high-resolution layer refers to the low-resolution layer. Therefore, when the high-resolution layer is decoded, since the low-resolution layer includes overlapping information, it is not required to display the low-resolution layer. Accordingly, the layer 512 having the maximum layer-identifier value may be included in the first output layer subset 560.

A second output layer subset 570 according to another embodiment may include all layers 511 included in the second layer set 520. In a case where a scalable video has a multiview scalability type, layers corresponding to a left view, a right view, and a central view may be included. The layers included in a layer set may be layers respectively corresponding to the left view, the right view, and the central view, and may be all displayed.

A third output layer subset 580 may include a layer 513 having a minimum layer-identifier value from among layers in the second layer set 520.

The scalable video decoding apparatus 14 may obtain an index indicating an output layer subset, and may determine, by using the obtained index, one output layer subset from among output layer subsets 540, 550, and 560.

The scalable video decoding apparatus 14 decodes and then displays a layer included in a determined target output layer subset.

As described above with reference to FIG. 5, it is assumed that a layer having the minimum layer-identifier value is the base layer, and a layer having the maximum layer-identifier value is a layer to be decoded or encoded last from among enhancement layers, but it is not limited thereto, and even if a layer-identifier value is great, the layer may be independently encoded without referring to another layer having a smaller layer-identifier value than the layer.

While it is described above by assuming that the layers shown in FIG. 5 are primary pictures, but it is not limited thereto, and the layers may include layers corresponding to auxiliary pictures. For example, the auxiliary pictures may include an alpha plane picture and a depth picture. However, the auxiliary pictures are only reference pictures used in decoding the primary pictures, and are not directly output and are displayed.

Therefore, the scalable video decoding apparatus 14 may determine, as an output layer subset, layers that exclude the layers corresponding to the auxiliary pictures.

As described above with reference to FIG. 6, it is assumed that the second layer set 520 is determined as the target output layer set, but it is not limited thereto, and thus, the scalable video decoding apparatus 14 may determine the output layer set group and may not determine in advance the target output layer set but may determine the target output layer set at a later time. In this case, the scalable video decoding apparatus 14 may determine output layer subsets for the layer sets 510, 520, and 530, respectively.

For example, the scalable video decoding apparatus 14 may determine an output layer set group including the layer sets 510, 520, and 530, may determine, as output layer subsets, layers having maximum layer-identifier values from the layer sets 510, 520, and 530, i.e., a layer 4 of the first layer set 510, a layer 3 of the second layer set 520, and a layer 2 of the third layer set 530, and may determine an output layer subset group including the output layer subsets. In this regard, the scalable video decoding apparatus 14 may determine the output layer subset group, based on an index indicating the output layer subset group.

When the scalable video decoding apparatus 14 determines the target output layer set, the scalable video decoding apparatus 14 may determine one target output layer subset from among the output layer subset group. That is, the target output layer subset including at least one layer, which is included in the target output layer set, may be determined. For example, when the scalable video decoding apparatus 14 determines the first layer set 510 as the target output layer set from among the output layer set group, the scalable video decoding apparatus 14 may determine the first output layer subset 560 from among the output layer subset group, and may determine, as an output layer, the layer 512 having the maximum layer-identifier value included in the first output layer subset 560.

FIG. 7 illustrates a block diagram of a video encoding apparatus based on coding units of a tree structure 100, according to various embodiments.

The video encoding apparatus involving video prediction based on coding units of the tree structure 100 includes a coding unit determiner 120 and an output unit 130. Hereinafter, for convenience of description, the video encoding apparatus involving video prediction based on coding units of the tree structure 100 is referred to as the ‘video encoding apparatus 100’.

The coding unit determiner 120 may split a current picture based on a largest coding unit that is a coding unit having a maximum size for a current picture of an image. If the current picture is larger than the largest coding unit, image data of the current picture may be split into the at least one largest coding unit. The largest coding unit according to an embodiment may be a data unit having a size of 32×32, 64×64, 128×128, 256×256, etc., wherein a shape of the data unit is a square having a width and length in squares of 2.

A coding unit according to an embodiment may be characterized by a maximum size and a depth. The depth denotes the number of times the coding unit is spatially split from the largest coding unit, and as the depth deepens, deeper coding units according to depths may be split from the largest coding unit to a smallest coding unit. A depth of the largest coding unit may be defined as an uppermost depth and a depth of the smallest coding unit may be defined as a lowermost depth. Since a size of a coding unit corresponding to each depth decreases as the depth of the largest coding unit deepens, a coding unit corresponding to an upper depth may include a plurality of coding units corresponding to lower depths.

As described above, the image data of the current picture is split into the largest coding units according to a maximum size of the coding unit, and each of the largest coding units may include deeper coding units that are split according to depths. Since the largest coding unit according to an embodiment is split according to depths, the image data of a spatial domain included in the largest coding unit may be hierarchically classified according to depths.

A maximum depth and a maximum size of a coding unit, which limit the total number of times a height and a width of the largest coding unit are hierarchically split, may be predetermined.

The coding unit determiner 120 encodes at least one split region obtained by splitting a region of the largest coding unit according to depths, and determines a depth to output a finally encoded image data according to the at least one split region. That is, the coding unit determiner 120 determines a final depth by encoding the image data in the deeper coding units according to depths, according to the largest coding unit of the current picture, and selecting a depth having the least encoding error. The determined final depth and image data according to largest coding units are output to the output unit 130.

The image data in the largest coding unit is encoded based on the deeper coding units corresponding to at least one depth equal to or below the maximum depth, and results of encoding the image data based on each of the deeper coding units are compared. A depth having the least encoding error may be selected after comparing encoding errors of the deeper coding units. At least one final depth may be selected for each largest coding unit.

The size of the largest coding unit is split as a coding unit is hierarchically split according to depths, and as the number of coding units increases. Also, even if coding units correspond to the same depth in one largest coding unit, it is determined whether to split each of the coding units corresponding to the same depth to a lower depth by measuring an encoding error of the image data of the each coding unit, separately. Accordingly, even when image data is included in one largest coding unit, the encoding errors may differ according to regions in the one largest coding unit, and thus the final depths may differ according to regions in the image data. Thus, one or more final depths may be determined in one largest coding unit, and the image data of the largest coding unit may be divided according to coding units of at least one final depth.

Accordingly, the coding unit determiner 120 according to the embodiment may determine coding units having a tree structure included in the largest coding unit. The ‘coding units having a tree structure’ according to an embodiment include coding units corresponding to a depth determined to be the final depth, from among all deeper coding units included in the largest coding unit. A coding unit of a final depth may be hierarchically determined according to depths in the same region of the largest coding unit, and may be independently determined in different regions. Equally, a final depth in a current region may be independently determined from a final depth in another region.

A maximum depth according to an embodiment is an index related to the number of splitting times from a largest coding unit to a smallest coding unit. A first maximum depth according to an embodiment may denote the total number of splitting times from the largest coding unit to the smallest coding unit. A second maximum depth according to an embodiment may denote the total number of depth levels from the largest coding unit to the smallest coding unit. For example, when a depth of the largest coding unit is 0, a depth of a coding unit, in which the largest coding unit is split once, may be set to 1, and a depth of a coding unit, in which the largest coding unit is split twice, may be set to 2. Here, if the smallest coding unit is a coding unit in which the largest coding unit is split four times, depth levels of depths 0, 1, 2, 3, and 4 exist, and thus the first maximum depth may be set to 4, and the second maximum depth may be set to 5.

Prediction encoding and transformation may be performed according to the largest coding unit. The prediction encoding and the transformation are also performed based on the deeper coding units according to a depth equal to or depths less than the maximum depth, according to the largest coding unit.

Since the number of deeper coding units increases whenever the largest coding unit is split according to depths, encoding, including the prediction encoding and the transformation, is performed on all of the deeper coding units generated as the depth deepens. Hereinafter, for convenience of description, the prediction encoding and the transformation will be described based on a coding unit of a current depth in at least one largest coding unit.

The video encoding apparatus 100 according to the embodiment may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 100 may select not only a coding unit for encoding the image data, but may also select a data unit different from the coding unit so as to perform the prediction encoding on the image data in the coding unit.

In order to perform prediction encoding in the largest coding unit, the prediction encoding may be performed based on a coding unit of a final depth, i.e., based on the coding unit that is no longer split. A partition obtained by splitting a prediction unit may include a coding unit and a data unit obtained by splitting at least one selected from a height and a width of the coding unit. A partition may include a data unit where a coding unit is split and a data unit having the same size as the coding unit. A partition that is a base of prediction may be referred to as a ‘prediction unit’.

For example, when a coding unit of 2N×2N (where N is a positive integer) is no longer split and becomes a prediction unit of 2N×2N, and a size of a partition may be 2N×2N, 2N×N, N×2N, or N×N. Examples of a partition mode may include symmetrical partitions obtained by symmetrically splitting a height or width of the prediction unit, and may selectively include partitions obtained by asymmetrically splitting the height or width of the prediction unit, such as 1:n or n:1, partitions obtained by geometrically splitting the prediction unit, and partitions having arbitrary shapes.

A prediction mode of the prediction unit may be at least one of an intra mode, an inter mode, and a skip mode. For example, the intra mode or the inter mode may be performed on the partition of 2N×2N, 2N×N, N×2N, or N×N. Also, the skip mode may be performed only on the partition of 2N×2N. The encoding may be independently performed on one prediction unit in a coding unit, thereby selecting a prediction mode having a least encoding error.

The video encoding apparatus 100 according to the embodiment may also perform the transformation on the image data in a coding unit based not only on the coding unit for encoding the image data, but also based on a data unit that is different from the coding unit. In order to perform the transformation in the coding unit, the transformation may be performed based on a data unit having a size smaller than or equal to the coding unit. For example, the transformation unit may include a data unit for an intra mode and a transformation unit for an inter mode.

The transformation unit in the coding unit may be recursively split into smaller sized regions in the similar manner as the coding unit according to the tree structure, thus, residual data of the coding unit may be divided according to the transformation unit having the tree structure according to a transformation depth.

A transformation depth indicating the number of splitting times to reach the transformation unit by splitting the height and width of the coding unit may also be set in the transformation unit. For example, in a current coding unit of 2N×2N, a transformation depth may be 0 when the size of a transformation unit is 2N×2N, may be 1 when the size of the transformation unit is N×N, and may be 2 when the size of the transformation unit is N/2×N/2. That is, with respect to the transformation unit, the transformation unit having the tree structure may be set according to the transformation depths.

Split information according to depths requires not only information about a depth but also requires information related to prediction and transformation. Accordingly, the coding unit determiner 120 may determine not only a depth generating a least encoding error but may also determine a partition mode in which a prediction unit is split to partitions, a prediction mode according to prediction units, and a size of a transformation unit for transformation.

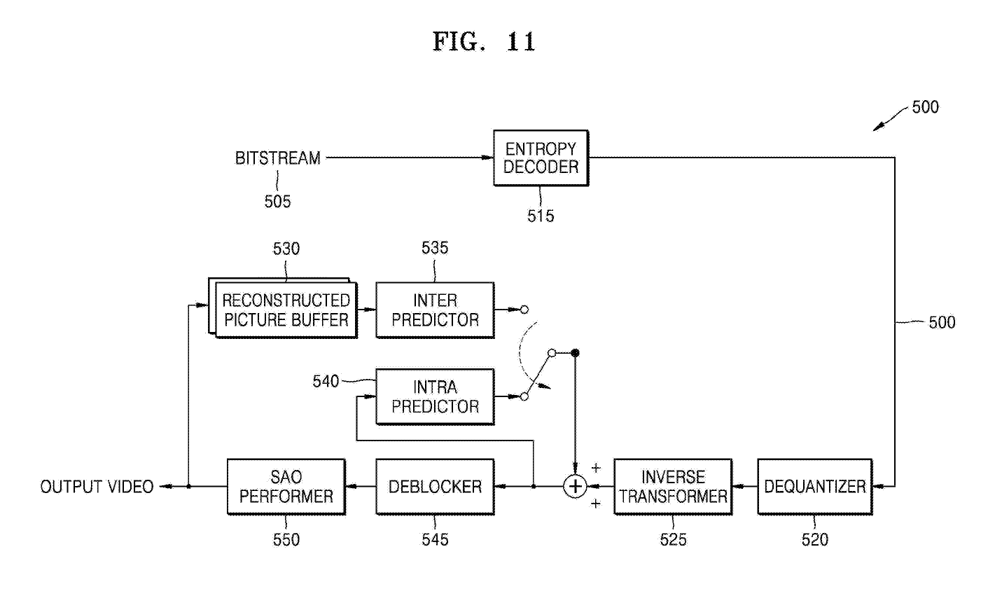

Coding units according to a tree structure in a largest coding unit and methods of determining a prediction unit/partition, and a transformation unit, according to embodiments, will be described in detail later with reference to FIGS. 9 through 19.

The coding unit determiner 120 may measure an encoding error of deeper coding units according to depths by using Rate-Distortion Optimization based on Lagrangian multipliers.

The output unit 130 outputs, in bitstreams, the image data of the largest coding unit, which is encoded based on the at least one depth determined by the coding unit determiner 120, and information according to depths.

The encoded image data may correspond to a result obtained by encoding residual data of an image.

The split information according to depths may include depth information, partition mode information of the prediction unit, prediction mode information, and the split information of the transformation unit.

Final depth information may be defined by using split information according to depths, which specifies whether encoding is performed on coding units of a lower depth instead of a current depth. If the current depth of the current coding unit is a depth, the current coding unit is encoded by using the coding unit of the current depth, and thus split information of the current depth may be defined not to split the current coding unit to a lower depth. On the contrary, if the current depth of the current coding unit is not the depth, the encoding has to be performed on the coding unit of the lower depth, and thus the split information of the current depth may be defined to split the current coding unit to the coding units of the lower depth.

If the current depth is not the depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one largest coding unit, and at least one piece of split information has to be determined for a coding unit of a depth, at least one piece of split information may be determined for one largest coding unit. Also, a depth of data of the largest coding unit may vary according to locations since the data is hierarchically split according to depths, and thus a depth and split information may be set for the data.

Accordingly, the output unit 130 according to the embodiment may assign encoding information about a corresponding depth and an encoding mode to at least one of the coding unit, the prediction unit, and a minimum unit included in the largest coding unit.

The minimum unit according to an embodiment is a square data unit obtained by splitting the smallest coding unit constituting the lowermost depth by 4. Alternatively, the minimum unit according to an embodiment may be a maximum square data unit that may be included in all of the coding units, prediction units, partition units, and transformation units included in the largest coding unit.

For example, the encoding information output by the output unit 130 may be classified into encoding information according to deeper coding units, and encoding information according to prediction units. The encoding information according to the deeper coding units may include the information about the prediction mode and about the size of the partitions. The encoding information according to the prediction units may include information about an estimated direction during an inter mode, about a reference image index of the inter mode, about a motion vector, about a chroma component of an intra mode, and about an interpolation method during the intra mode.

Information about a maximum size of the coding unit defined according to pictures, slices, or GOPs, and information about a maximum depth may be inserted into a header of a bitstream, a sequence parameter set, or a picture parameter set.

Information about a maximum size of the transformation unit allowed with respect to a current video, and information about a minimum size of the transformation unit may also be output through a header of a bitstream, a sequence parameter set, or a picture parameter set. The output unit 130 may encode and output reference information, prediction information, and slice type information, which are related to prediction.

According to the simplest embodiment for the video encoding apparatus 100, the deeper coding unit may be a coding unit obtained by dividing a height or width of a coding unit of an upper depth, which is one layer above, by two. That is, when the size of the coding unit of the current depth is 2N×2N, the size of the coding unit of the lower depth is N×N. Also, a current coding unit having a size of 2N×2N may maximally include four lower-depth coding units having a size of N×N.

Accordingly, the video encoding apparatus 100 may form the coding units having the tree structure by determining coding units having an optimum shape and an optimum size for each largest coding unit, based on the size of the largest coding unit and the maximum depth determined considering characteristics of the current picture. Also, since encoding may be performed on each largest coding unit by using any one of various prediction modes and transformations, an optimal encoding mode may be determined by taking into account characteristics of the coding unit of various image sizes.

Thus, if an image having a high resolution or a large data amount is encoded in a conventional macroblock, the number of macroblocks per picture excessively increases. Accordingly, the number of pieces of compressed information generated for each macroblock increases, and thus it is difficult to transmit the compressed information and data compression efficiency decreases. However, by using the video encoding apparatus according to the embodiment, image compression efficiency may be increased since a coding unit is adjusted while considering characteristics of an image while increasing a maximum size of a coding unit while considering a size of the image.

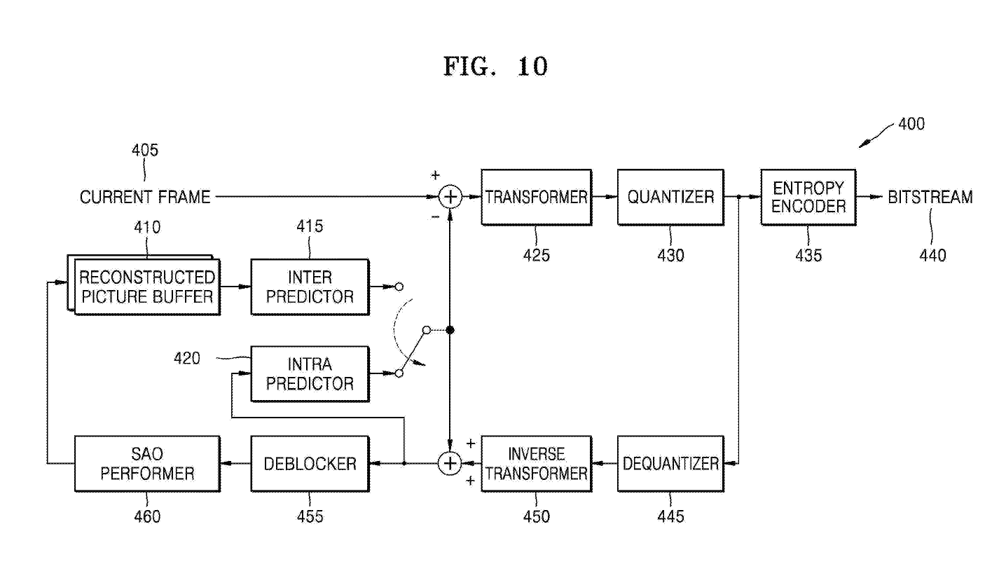

FIG. 8 illustrates a block diagram of a video decoding apparatus based on coding units of a tree structure 200, according to various embodiments.

The video decoding apparatus involving video prediction based on coding units of the tree structure 200 according to the embodiment includes a receiver 210, an image data and encoding information extractor 220, and an image data decoder 230. Hereinafter, for convenience of description, the video decoding apparatus involving video prediction based on coding units of the tree structure 200 according to the embodiment is referred to as the ‘video decoding apparatus 200’.

Definitions of various terms, such as a coding unit, a depth, a prediction unit, a transformation unit, and various types of split information for decoding operations of the video decoding apparatus 200 according to the embodiment are identical to those described with reference to FIG. 7 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each largest coding unit, and outputs the extracted image data to the image data decoder 230. The image data and encoding information extractor 220 may extract information about a maximum size of a coding unit of a current picture, from a header about the current picture, a sequence parameter set, or a picture parameter set.

Also, the image data and encoding information extractor 220 extracts, from the parsed bitstream, a final depth and split information about the coding units having a tree structure according to each largest coding unit. The extracted final depth and the extracted split information are output to the image data decoder 230. That is, the image data in a bit stream is split into the largest coding unit so that the image data decoder 230 may decode the image data for each largest coding unit.

A depth and split information according to each of the largest coding units may be set for one or more pieces of depth information, and split information according to depths may include partition mode information of a corresponding coding unit, prediction mode information, and split information of a transformation unit. Also, as the depth information, the split information according to depths may be extracted.

The depth and the split information according to each of the largest coding units extracted by the image data and encoding information extractor 220 are a depth and split information determined to generate a minimum encoding error when an encoder, such as the video encoding apparatus 100, repeatedly performs encoding for each deeper coding unit according to depths according to each largest coding unit. Accordingly, the video decoding apparatus 200 may reconstruct an image by decoding data according to an encoding method that generates the minimum encoding error.

Since encoding information about the depth and the encoding mode may be assigned to a predetermined data unit from among a corresponding coding unit, a prediction unit, and a minimum unit, the image data and encoding information extractor 220 may extract the depth and the split information according to the predetermined data units. If a depth and split information of a corresponding largest coding unit are recorded according to each of the predetermined data units, predetermined data units having the same depth and the split information may be inferred to be the data units included in the same largest coding unit.

The image data decoder 230 reconstructs the current picture by decoding the image data in each largest coding unit based on the depth and the split information according to each of the largest coding units. That is, the image data decoder 230 may decode the encoded image data, based on a read partition mode, a prediction mode, and a transformation unit for each coding unit from among the coding units having the tree structure included in each largest coding unit. A decoding process may include a prediction process including intra prediction and motion compensation, and an inverse transformation process.

The image data decoder 230 may perform intra prediction or motion compensation according to a partition and a prediction mode of each coding unit, based on the information about the partition type and the prediction mode of the prediction unit of the coding unit according to depths.

In addition, for inverse transformation for each largest coding unit, the image data decoder 230 may read information about a transformation unit according to a tree structure for each coding unit so as to perform inverse transformation based on transformation units for each coding unit. Due to the inverse transformation, a pixel value of a spatial domain of the coding unit may be reconstructed.

The image data decoder 230 may determine a depth of a current largest coding unit by using split information according to depths. If the split information indicates that image data is no longer split in the current depth, the current depth is a depth. Accordingly, the image data decoder 230 may decode the image data of the current largest coding unit by using the information about the partition mode of the prediction unit, the prediction mode, and the size of the transformation unit for each coding unit corresponding to the current depth.

That is, data units containing the encoding information including the same split information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode. As such, the current coding unit may be decoded by obtaining the information about the encoding mode for each coding unit.

The image decoding apparatus 30 described above with reference to FIG. 3A may include the video decoding apparatuses 200 corresponding to the number of views, so as to reconstruct first layer images and second layer images by decoding a received first layer image stream and a received second layer image stream.

When the first layer image stream is received, the image data decoder 230 of the video decoding apparatus 200 may split samples of the first layer images, which are extracted from the first layer image stream by an extractor 220, into coding units according to a tree structure of a largest coding unit. The image data decoder 230 may perform motion compensation, based on prediction units for the inter-image prediction, on each of the coding units according to the tree structure of the samples of the first layer images, and may reconstruct the first layer images.

When the second layer image stream is received, the image data decoder 230 of the video decoding apparatus 200 may split samples of the second layer images, which are extracted from the second layer image stream by the extractor 220, into coding units according to a tree structure of a largest coding unit. The image data decoder 230 may perform motion compensation, based on prediction units for the inter-image prediction, on each of the coding units of the samples of the second layer images, and may reconstruct the second layer images.

The extractor 220 may obtain, from a bitstream, information related to a luminance error so as to compensate for a luminance difference between the first layer image and the second layer image. However, whether to perform luminance compensation may be determined according to an encoding mode of a coding unit. For example, the luminance compensation may be performed only on a prediction unit having a size of 2N×2N.

Thus, the video decoding apparatus 200 may obtain information about at least one coding unit that generates the minimum encoding error when encoding is recursively performed for each largest coding unit, and may use the information to decode the current picture. That is, the coding units having the tree structure determined to be the optimum coding units in each largest coding unit may be decoded.

Accordingly, even if an image has high resolution or has an excessively large data amount, the image may be efficiently decoded and reconstructed by using a size of a coding unit and an encoding mode, which are adaptively determined according to characteristics of the image, by using optimal split information received from an encoding terminal.

FIG. 9 illustrates a concept of coding units, according to various embodiments.

A size of a coding unit may be expressed by width×height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

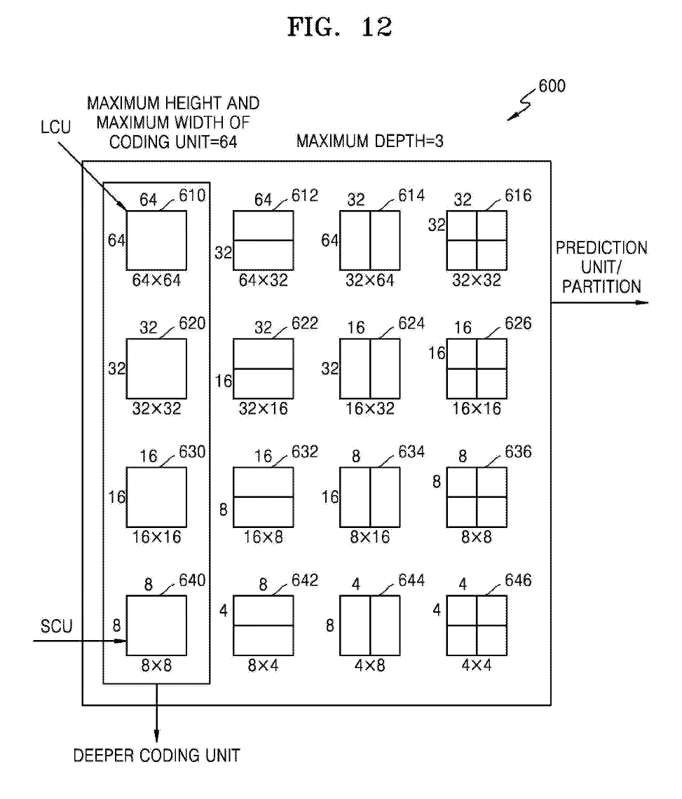

In video data 310, a resolution is 1220×1080, a maximum size of a coding unit is 64, and a maximum depth is 2. In video data 320, a resolution is 1220×1080, a maximum size of a coding unit is 64, and a maximum depth is 3. In video data 330, a resolution is 352×288, a maximum size of a coding unit is 16, and a maximum depth is 1. The maximum depth shown in FIG. 10 denotes the total number of splits from a largest coding unit to a smallest coding unit.

If a resolution is high or a data amount is large, it is preferable that a maximum size of a coding unit is large so as to not only increase encoding efficiency but also to accurately reflect characteristics of an image. Accordingly, the maximum size of the coding unit of the video data 310 and 320 having a higher resolution than the video data 330 may be selected to 64.

Since the maximum depth of the video data 310 is 2, coding units 315 of the video data 310 may include a largest coding unit having a long axis size of 64, and coding units having long axis sizes of 32 and 16 since depths are deepened to two layers by splitting the largest coding unit twice. On the other hand, since the maximum depth of the video data 330 is 1, coding units 335 of the video data 330 may include a largest coding unit having a long axis size of 16, and coding units having a long axis size of 8 since depths are deepened to one layer by splitting the largest coding unit once.

Since the maximum depth of the video data 320 is 3, coding units 325 of the video data 320 may include a largest coding unit having a long axis size of 64, and coding units having long axis sizes of 32, 16, and 8 since the depths are deepened to 3 layers by splitting the largest coding unit three times. As a depth deepens, an expression capability with respect to detailed information may be improved.

FIG. 10 illustrates a block diagram of an image encoder 400 based on coding units, according to various embodiments.

The image encoder 400 according to an embodiment performs operations of a picture encoder 120 of the video encoding apparatus 100 so as to encode image data. That is, an intra predictor 420 performs intra prediction on coding units in an intra mode, from among a current image 405, and an inter predictor 415 performs inter prediction on coding units in an inter mode by using the current image 405 and a reference image obtained from a reconstructed picture buffer 410 according to prediction units. The current image 405 may be split into largest coding units and then the largest coding units may be sequentially encoded. In this regard, the largest coding units that are to be split into coding units having a tree structure may be encoded.

Residue data is generated by removing prediction data regarding a coding unit of each mode which is output from the intra predictor 420 or the inter predictor 415 from data regarding an encoded coding unit of the current image 405, and the residue data is output as a quantized transformation coefficient according to transformation units through a transformer 425 and a quantizer 430. The quantized transformation coefficient is reconstructed as the residue data in a spatial domain through an inverse-quantizer 445 and an inverse-transformer 450. The reconstructed residual image data in the spatial domain is added to prediction data for the coding unit of each mode which is output from the intra predictor 420 or the inter predictor 415 and thus is reconstructed as data in a spatial domain for a coding unit of the current image 405. The reconstructed data in the spatial domain is generated as a reconstructed image through a deblocking unit 455 and an SAO performer 460 and the reconstructed image is stored in the reconstructed picture buffer 410. The reconstructed images stored in the reconstructed picture buffer 410 may be used as reference images for inter predicting another image. The transformation coefficient quantized by the transformer 425 and the quantizer 430 may be output as a bitstream 440 through an entropy encoder 435.

In order for the image encoder 400 to be applied in the video encoding apparatus 100, all elements of the image encoder 400, i.e., the inter predictor 415, the intra predictor 420, the transformer 425, the quantizer 430, the entropy encoder 435, the inverse-quantizer 445, the inverse-transformer 450, the deblocking unit 455, and the SAO performer 460, may perform operations based on each coding unit among coding units having a tree structure according to each largest coding unit.

In particular, the intra predictor 420 and the inter predictor 415 may determine a partition mode and a prediction mode of each coding unit from among the coding units having a tree structure, by taking into account the maximum size and the maximum depth of a current largest coding unit, and the transformer 425 may determine whether to split a transformation unit according to a quad tree in each coding unit from among the coding units having a tree structure.

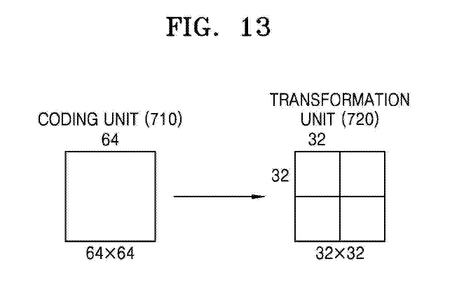

FIG. 11 illustrates a block diagram of an image decoder 500 based on coding units, according to various embodiments.

An entropy decoder 515 parses, from a bitstream 505, encoded image data to be decoded and encoding information required for decoding. The encoded image data corresponds to a quantized transformation coefficient, and an inverse-quantizer 520 and an inverse-transformer 525 reconstruct residue data from the quantized transformation coefficient.

An intra predictor 540 performs intra prediction on a coding unit in an intra mode according to prediction units. An inter predictor 535 performs inter prediction by using a reference image with respect to a coding unit in an inter mode from among a current image, wherein the reference image is obtained by a reconstructed picture buffer 530 according to prediction units.

Prediction data and residue data regarding coding units of each mode, which passed through the intra predictor 540 and the inter predictor 535, are summed, so that data in a spatial domain regarding coding units of the current image 405 may be reconstructed, and the reconstructed data in the spatial domain may be output as a reconstructed image 560 through a deblocking unit 545 and an SAO performer 550. Reconstructed images stored in the reconstructed picture buffer 530 may be output as reference images.

In order for a picture decoder 230 of the video decoding apparatus 200 to decode the image data, operations after the entropy decoder 515 of the image decoder 500 according to an embodiment may be performed.

In order for the image decoder 500 to be applied in the video decoding apparatus 200 according to an embodiment, all elements of the image decoder 500, i.e., the entropy decoder 515, the inverse-quantizer 520, the inverse-transformer 525, the intra predictor 540, the inter predictor 535, the deblocking unit 545, and the SAO performer 550 may perform operations based on coding units having a tree structure for each largest coding unit.

In particular, the intra predictor 540 and the inter predictor 535 may determine a partition mode and a prediction mode of each coding unit from among the coding units according to a tree structure, and the inverse-transformer 525 may determine whether or not to split a transformation unit according to a quad tree in each coding unit.

The encoding operation of FIG. 10 and the decoding operation of FIG. 11 are described as a video stream encoding operation and a video stream decoding operation, respectively, in a single layer. Thus, if the image encoding apparatus 40 of FIG. 3BA encodes a video stream of two or more layers, the image encoder 400 may be provided for each layer. Similarly, if the decoding apparatus 30 of FIG. 3A decodes a video stream of two or more layers, the image decoder 500 may be provided for each layer.

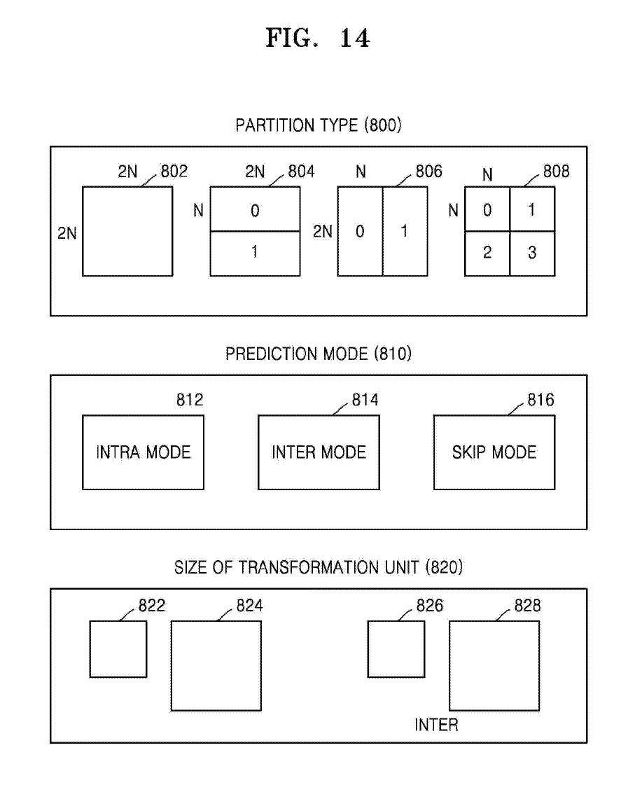

FIG. 12 illustrates deeper coding units according to depths, and partitions, according to various embodiments.

The video encoding apparatus 100 according to an embodiment and the video decoding apparatus 200 according to an embodiment use hierarchical coding units so as to consider characteristics of an image. A maximum height, a maximum width, and a maximum depth of coding units may be adaptively determined according to the characteristics of the image, or may be variously set according to user requirements. Sizes of deeper coding units according to depths may be determined according to the predetermined maximum size of the coding unit.

In a hierarchical structure of coding units 600 according to an embodiment, the maximum height and the maximum width of the coding units are each 64, and the maximum depth is 3. In this case, the maximum depth represents a total number of times the coding unit is split from the largest coding unit to the smallest coding unit. Since a depth deepens along a vertical axis of the hierarchical structure of coding units 600, a height and a width of the deeper coding unit are each split. Also, a prediction unit and partitions, which are bases for prediction encoding of each deeper coding unit, are shown along a horizontal axis of the hierarchical structure of coding units 600.

That is, a coding unit 610 is a largest coding unit in the hierarchical structure of coding units 600, wherein a depth is 0 and a size, i.e., a height by width, is 64×64. The depth deepens along the vertical axis, and a coding unit 620 having a size of 32×32 and a depth of 1, a coding unit 630 having a size of 16×16 and a depth of 2, and a coding unit 640 having a size of 8×8 and a depth of 3. The coding unit 640 having the size of 8×8 and the depth of 3 is a smallest coding unit.

The prediction unit and the partitions of a coding unit are arranged along the horizontal axis according to each depth. That is, if the coding unit 610 having a size of 64×64 and a depth of 0 is a prediction unit, the prediction unit may be split into partitions included in the coding unit 610 having the size of 64×64, i.e. a partition 610 having a size of 64×64, partitions 612 having the size of 64×32, partitions 614 having the size of 32×64, or partitions 616 having the size of 32×32.

Equally, a prediction unit of the coding unit 620 having the size of 32×32 and the depth of 1 may be split into partitions included in the coding unit 620, i.e. a partition 620 having a size of 32×32, partitions 622 having a size of 32×16, partitions 624 having a size of 16×32, and partitions 626 having a size of 16×16.

Equally, a prediction unit of the coding unit 630 having the size of 16×16 and the depth of 2 may be split into partitions included in the coding unit 630, i.e. a partition having a size of 16×16 included in the coding unit 630, partitions 632 having a size of 16×8, partitions 634 having a size of 8×16, and partitions 636 having a size of 8×8.

Equally, a prediction unit of the coding unit 640 having the size of 8×8 and the depth of 3 may be split into partitions included in the coding unit 640, i.e. a partition 640 having a size of 8×8 included in the coding unit 640, partitions 642 having a size of 8×4, partitions 644 having a size of 4×8, and partitions 646 having a size of 4×4.

In order to determine a depth of the largest coding unit 610, the coding unit determiner 120 of the video encoding apparatus 100 has to perform encoding on coding units respectively corresponding to depths included in the largest coding unit 610.

The number of deeper coding units according to depths including data in the same range and the same size increases as the depth deepens. For example, four coding units corresponding to a depth of 2 are required to cover data that is included in one coding unit corresponding to a depth of 1. Accordingly, in order to compare results of encoding the same data according to depths, the data has to be encoded by using each of the coding unit corresponding to the depth of 1 and four coding units corresponding to the depth of 2.

In order to perform encoding according to each of the depths, a least encoding error that is a representative encoding error of a corresponding depth may be selected by performing encoding on each of prediction units of the coding units according to depths, along the horizontal axis of the hierarchical structure of coding units 600. Also, the minimum encoding error may be searched for by comparing representative encoding errors according to depths, by performing encoding for each depth as the depth deepens along the vertical axis of the hierarchical structure of coding units 600. A depth and a partition generating the minimum encoding error in the largest coding unit 610 may be selected as a depth and a partition mode of the largest coding unit 610.

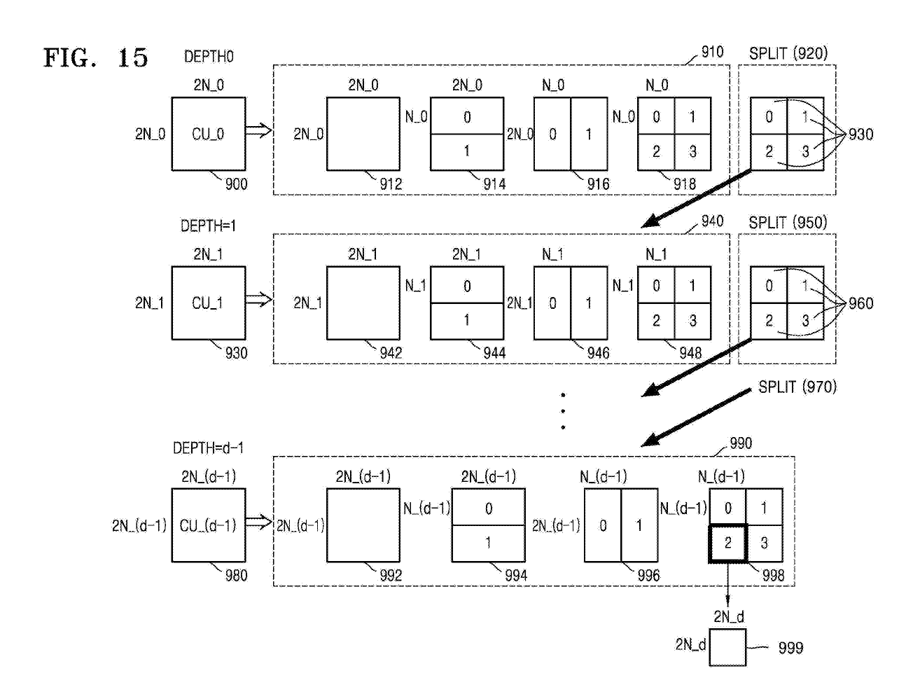

FIG. 13 illustrates a relationship between a coding unit and transformation units, according to various embodiments.

The video encoding apparatus 100 according to an embodiment or the video decoding apparatus 200 according to an embodiment encodes or decodes an image according to coding units having sizes smaller than or equal to a largest coding unit for each largest coding unit. Sizes of transformation units for transformation during an encoding process may be selected based on data units that are not larger than a corresponding coding unit.

For example, in the video encoding apparatus 100 or the video decoding apparatus 200, when a size of the coding unit 710 is 64×64, transformation may be performed by using the transformation units 720 having a size of 32×32.

Also, data of the coding unit 710 having the size of 64×64 may be encoded by performing the transformation on each of the transformation units having the size of 32×32, 16×16, 8×8, and 4×4, which are smaller than 64×64, and then a transformation unit having the least coding error with respect to an original image may be selected.

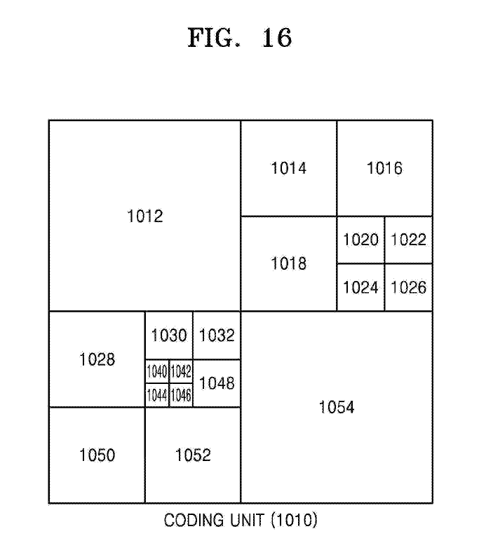

FIG. 14 illustrates a plurality of pieces of encoding information, according to various embodiments.

The output unit 130 of the video encoding apparatus 100 according to an embodiment may encode and transmit, as split information, partition mode information 800, prediction mode information 810, and transformation unit size information 820 for each coding unit corresponding to a depth.

The partition mode information 800 indicates information about a shape of a partition obtained by splitting a prediction unit of a current coding unit, wherein the partition is a data unit for prediction encoding the current coding unit. For example, a current coding unit CU_0 having a size of 2N×2N may be split into any one of a partition 802 having a size of 2N×2N, a partition 804 having a size of 2N×N, a partition 806 having a size of N×2N, and a partition 808 having a size of N×N. In this case, the partition mode information 800 about a current coding unit is set to indicate one of the partition 802 having a size of 2N×2N, the partition 804 having a size of 2N×N, the partition 806 having a size of N×2N, and the partition 808 having a size of N×N.

The prediction mode information 810 indicates a prediction mode of each partition. For example, the prediction mode information 810 may indicate a mode of prediction encoding performed on a partition indicated by the partition mode information 800, i.e., an intra mode 812, an inter mode 814, or a skip mode 816.

The transformation unit size information 820 represents a transformation unit to be based on when transformation is performed on a current coding unit. For example, the transformation unit may be one of a first intra transformation unit 822, a second intra transformation unit 824, a first inter transformation unit 826, and a second inter transformation unit 828.

The image data and encoding information extractor 810 of the video decoding apparatus 200 may extract and use the partition mode information 800, the prediction mode information 810, and the transformation unit size information 820 for decoding, according to each deeper coding unit.

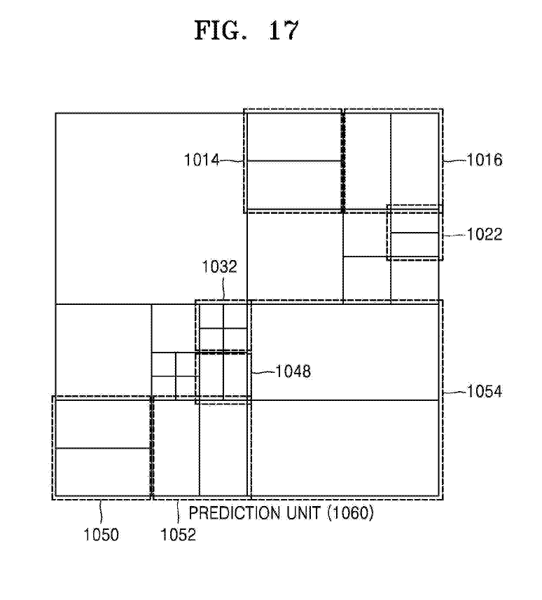

FIG. 15 illustrates deeper coding units according to depths, according to various embodiments.

Split information may be used to represent a change in a depth. The spilt information specifies whether a coding unit of a current depth is split into coding units of a lower depth.

A prediction unit 910 for prediction encoding a coding unit 900 having a depth of 0 and a size of 2N_0×2N_0 may include partitions of a partition mode 912 having a size of 2N_0×2N_0, a partition mode 914 having a size of 2N_0×N_0, a partition mode 916 having a size of N_0×2N_0, and a partition mode 918 having a size of N_0×N_0. Only the partition modes 912, 914, 916, and 918 which are obtained by symmetrically splitting the prediction unit are illustrated, but as described above, a partition mode is not limited thereto and may include asymmetrical partitions, partitions having a predetermined shape, and partitions having a geometrical shape.

According to each partition mode, prediction encoding has to be repeatedly performed on one partition having a size of 2N_0×2N_0, two partitions having a size of 2N_0×N_0, two partitions having a size of N_0×2N_0, and four partitions having a size of N_0×N_0. The prediction encoding in an intra mode and an inter mode may be performed on the partitions having the sizes of 2N_0×2N_0, N_0×2N_0, 2N_0×N_0, and N_0×N_0. The prediction encoding in a skip mode may be performed only on the partition having the size of 2N_0×2N_0.

If an encoding error is smallest in one of the partition modes 912, 914, and 916 having the sizes of 2N_0×2N_0, 2 N_0×N_0 and N_0×2N_0, the prediction unit 910 may not be split into a lower depth.

If the encoding error is the smallest in the partition mode 918 having the size of N_0×N_0, a depth is changed from 0 to 1 and split is performed (operation 920), and encoding may be repeatedly performed on coding units 930 of a partition mode having a depth of 2 and a size of N_0×N_0 so as to search for a minimum encoding error.

A prediction unit 940 for prediction encoding the coding unit 930 having a depth of 1 and a size of 2N_1×2N_1 (=N_0×N_0) may include a partition mode 942 having a size of 2N_1×2N_1, a partition mode 944 having a size of 2N_1×N_1, a partition mode 946 having a size of N_1×2N_1, and a partition mode 948 having a size of N_1×N_1.

If an encoding error is the smallest in the partition mode 948 having the size of N_1×N_1, a depth is changed from 1 to 2 and split is performed (in operation 950), and encoding is repeatedly performed on coding units 960 having a depth of 2 and a size of N_2×N_2 so as to search for a minimum encoding error.

When a maximum depth is d, deeper coding units according to depths may be set until when a depth corresponds to d−1, and split information may be set until when a depth corresponds to d−2. That is, when encoding is performed up to when the depth is d−1 after a coding unit corresponding to a depth of d−2 is split (in operation 970), a prediction unit 990 for prediction encoding a coding unit 980 having a depth of d−1 and a size of 2N_(d−1)×2N_(d−1) may include partitions of a partition mode 992 having a size of 2N_(d−1)×2N_(d−1), a partition mode 994 having a size of 2N_(d−1)×N_(d−1), a partition mode 996 having a size of N_(d−1)×2N_(d−1), and a partition mode 998 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition modes so as to search for a partition mode generating a minimum encoding error.

Even when the partition type 998 having the size of N_(d−1)×N_(d−1) has the minimum encoding error, since a maximum depth is d, a coding unit CU_(d−1) having a depth of d−1 is no longer split into a lower depth, and a depth for the coding units constituting a current largest coding unit 900 is determined to be d−1 and a partition mode of the current largest coding unit 900 may be determined to be N_(d−1)×N_(d−1). Also, since the maximum depth is d, split information for a coding unit 952 having a depth of d−1 is not set.

A data unit 999 may be a ‘minimum unit’ for the current largest coding unit. A minimum unit according to the embodiment may be a square data unit obtained by splitting a smallest coding unit having a lowermost depth by 4. By performing the encoding repeatedly, the video encoding apparatus 100 according to the embodiment may select a depth having the least encoding error by comparing encoding errors according to depths of the coding unit 900 to determine a depth, and set a corresponding partition type and a prediction mode as an encoding mode of the depth.

As such, the minimum encoding errors according to depths are compared in all of the depths of 0, 1, . . . , d−1, d, and a depth having the least encoding error may be determined as a depth. The depth, the partition mode of the prediction unit, and the prediction mode may be encoded and transmitted as split information. Also, since a coding unit has to be split from a depth of 0 to a depth, only split information of the depth is set to ‘0’, and split information of depths excluding the depth is set to ‘1’.

The image data and encoding information extractor 220 of the video decoding apparatus 200 according to the embodiment may extract and use a depth and prediction unit information about the coding unit 900 so as to decode the coding unit 912. The video decoding apparatus 200 according to the embodiment may determine a depth, in which split information is ‘0’, as a depth by using split information according to depths, and may use, for decoding, split information about the corresponding depth.

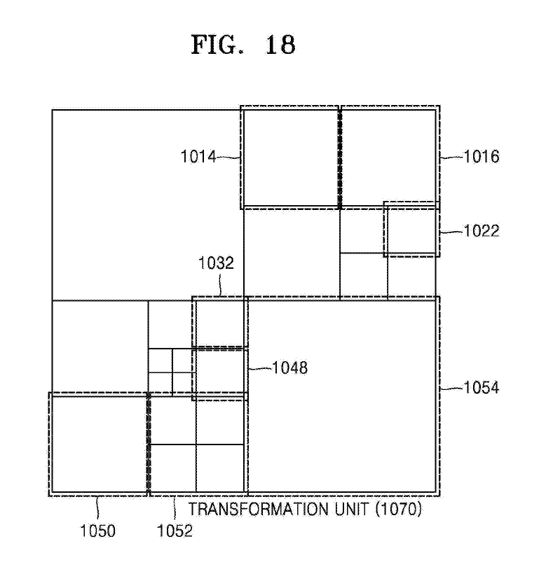

FIGS. 16, 17, and 18 illustrate a relationship between coding units, prediction units, and transformation units, according to various embodiments.

Coding units 1010 are deeper coding units according to depths determined by the video encoding apparatus 100, in a largest coding unit. Prediction units 1060 are partitions of prediction units of each of the Coding units 1010 according to depths, and transformation units 1070 are transformation units of each of the coding units according to depths.

When a depth of a largest coding unit is 0 in the deeper Coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

Some partitions 1014, 1016, 1022, 1032, 1048, 1050, 1052, and 1054 from among the Prediction units 1060 are obtained by splitting the coding unit. That is, partitions 1014, 1022, 1050, and 1054 are a partition mode having a size of 2N×N, partitions 1016, 1048, and 1052 are a partition mode having a size of N×2N, and a partition 1032 is a partition mode having a size of N×N. Prediction units and partitions of the deeper coding units 1010 are smaller than or equal to each coding unit.

Transformation or inverse transformation is performed on image data of the coding unit 1052 in the transformation units 1070 in a data unit that is smaller than the coding unit 1052. Also, the coding units 1014, 1016, 1022, 1032, 1048, 1050, 1052, and 1054 in the transformation units 1760 are data units different from those in the Prediction units 1060 in terms of sizes and shapes. That is, the video encoding apparatus 100 and the video decoding apparatus 200 according to the embodiments may perform intra prediction/motion estimation/motion compensation/and transformation/inverse transformation on an individual data unit in the same coding unit.

Accordingly, encoding is recursively performed on each of coding units having a hierarchical structure in each region of a largest coding unit so as to determine an optimum coding unit, and thus coding units according to a recursive tree structure may be obtained. Encoding information may include split information about a coding unit, partition mode information, prediction mode information, and transformation unit size information. Table 1 below shows the encoding information that may be set by the video encoding apparatus 100 and the video decoding apparatus 200 according to the embodiments.

TABLE 1

| Split Information 0 | | | | | |
|---|---|---|---|---|---|
| (Encoding on Coding Unit having Size of 2N × 2N and Current Depth of d) | | | | | |
| | | | Size of Transformation Unit | | |
| | | | Split | Split | |
| | Partition Type | | Information 0 | Information 1 | |
| | Symmetrical | Asymmetrical | of | of | |
| Prediction | Partition | Partition | Transformation | Transformation | Split |
| Mode | Type | Type | Unit | Unit | Information 1 |
| Intra | 2N × 2N | 2N × nU | 2N × 2N | N × N | Repeatedly |
| Inter | 2N × N | 2N × nD | | (Symmetrical | Encode |
| Skip | N × 2N | nL × 2N | | Partition Type) | Coding |
| (Only | N × N | nR × 2N | | N/2 × N/2 | Units |
| 2N × 2N) | | | | (Asymmetrical | having |
| | | | | Partition Type) | Lower |
| | | | | | Depth of |
| | | | | | d + 1 |

The output unit 130 of the video encoding apparatus 100 according to the embodiment may output the encoding information about the coding units having a tree structure, and the image data and encoding information extractor 220 of the video decoding apparatus 200 according to the embodiment may extract the encoding information about the coding units having a tree structure from a received bitstream.

Split information specifies whether a current coding unit is split into coding units of a lower depth. If split information of a current depth d is 0, a depth, in which a current coding unit is no longer split into a lower depth, is a depth, and thus partition mode information, prediction mode information, and transformation unit size information may be defined for the depth. If the current coding unit has to be further split according to the split information, encoding has to be independently performed on each of four split coding units of a lower depth.

A prediction mode may be one of an intra mode, an inter mode, and a skip mode. The intra mode and the inter mode may be defined in all partition modes, and the skip mode is defined only in a partition mode having a size of 2N×2N.

The partition mode information may indicate symmetrical partition modes having sizes of 2N×2N, 2N×N, N×2N, and N×N, which are obtained by symmetrically splitting a height or a width of a prediction unit, and asymmetrical partition modes having sizes of 2N×nU, 2N×nD, nL×2N, and nR×2N, which are obtained by asymmetrically splitting the height or width of the prediction unit. The asymmetrical partition modes having the sizes of 2N×nU and 2N×nD may be respectively obtained by splitting the height of the prediction unit in 1:3 and 3:1, and the asymmetrical partition modes having the sizes of nL×2N and nR×2N may be respectively obtained by splitting the width of the prediction unit in 1:3 and 3:1.

The size of the transformation unit may be set to be two types in the intra mode and two types in the inter mode. That is, if split information of the transformation unit is 0, the size of the transformation unit may be 2N×2N, which is the size of the current coding unit. If split information of the transformation unit is 1, the transformation units may be obtained by splitting the current coding unit. Also, if a partition mode of the current coding unit having the size of 2N×2N is a symmetrical partition mode, a size of a transformation unit may be N×N, and if the partition mode of the current coding unit is an asymmetrical partition mode, the size of the transformation unit may be N/2×N/2.

The encoding information about coding units having a tree structure according to the embodiment may be assigned to at least one of a coding unit corresponding to a depth, a prediction unit, and a minimum unit. The coding unit corresponding to the depth may include at least one of a prediction unit and a minimum unit containing the same encoding information.

Accordingly, it is determined whether adjacent data units are included in the same coding unit corresponding to the depth by comparing encoding information of the adjacent data units. Also, a corresponding coding unit corresponding to a depth is determined by using encoding information of a data unit, and thus a distribution of depths in a largest coding unit may be inferred.

Accordingly, if a current coding unit is predicted based on encoding information of adjacent data units, encoding information of data units in deeper coding units adjacent to the current coding unit may be directly referred to and used.

In another embodiment, if a current coding unit is predicted based on encoding information of adjacent data units, data units adjacent to the current coding unit may be searched by using encoded information of the data units, and the searched adjacent coding units may be referred for predicting the current coding unit.

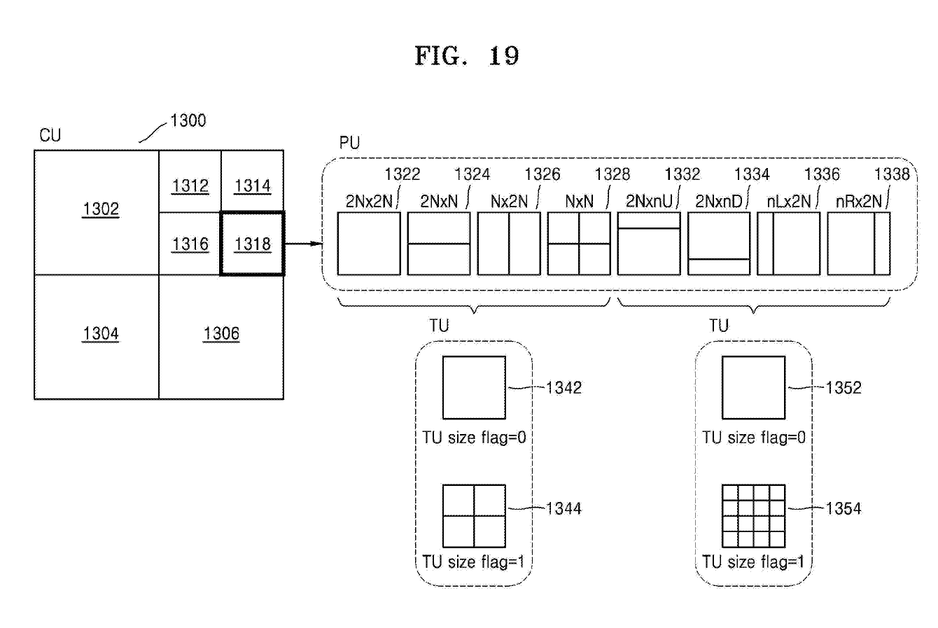

FIG. 19 illustrates a relationship between a coding unit, a prediction unit, and a transformation unit, according to encoding mode information of Table 1.

A largest coding unit 1300 includes coding units 1302, 1304, 1306, 1312, 1314, 1316, and 1318 of depths. Here, since the coding unit 1318 is a coding unit of a depth, split information may be set to 0. Partition mode information of the coding unit 1318 having a size of 2N×2N may be set to be one of partition modes including 2N×2N 1322, 2N×N 1324, N×2N 1326, N×N 1328, 2N×nU 1332, 2N×nD 1334, nL×2N 1336, and nR×2N 1338.

Transformation unit split information (TU size flag) is a type of a transformation index, and a size of a transformation unit corresponding to the transformation index may be changed according to a prediction unit type or partition mode of the coding unit.

For example, when the partition mode information is set to be one of symmetrical partition modes 2N×2N 1322, 2N×N 1324, N×2N 1326, and N×N 1328, if the transformation unit split information is 0, a transformation unit 1342 having a size of 2N×2N is set, and if the transformation unit split information is 1, a transformation unit 1344 having a size of N×N may be set.

When the partition mode information is set to be one of asymmetrical partition modes 2N×nU 1332, 2N×nD 1334, nL×2N 1336, and nR×2N 1338, if the transformation unit split information (TU size flag) is 0, a transformation unit 1352 having a size of 2N×2N may be set, and if the transformation unit split information is 1, a transformation unit 1354 having a size of N/2×N/2 may be set.

The transformation unit split information (TU size flag) described above with reference to FIG. 19 is a flag having a value or 0 or 1, but the transformation unit split information according to an embodiment is not limited to a flag having 1 bit, and the transformation unit may be hierarchically split while the transformation unit split information increases in a manner of 0, 1, 2, 3. etc., according to setting. The transformation unit split information may be an example of the transformation index.

In this case, the size of a transformation unit that has been actually used may be expressed by using the transformation unit split information according to the embodiment, together with a maximum size of the transformation unit and a minimum size of the transformation unit. The video encoding apparatus 100 according to the embodiment may encode maximum transformation unit size information, minimum transformation unit size information, and maximum transformation unit split information. The result of encoding the maximum transformation unit size information, the minimum transformation unit size information, and the maximum transformation unit split information may be inserted into an SPS. The video decoding apparatus 200 according to the embodiment may decode video by using the maximum transformation unit size information, the minimum transformation unit size information, and the maximum transformation unit split information.

For example, (a) if the size of a current coding unit is 64×64 and a maximum transformation unit size is 32×32, (a−1) then the size of a transformation unit may be 32×32 when a TU size flag is 0, (a−2) may be 16×16 when the TU size flag is 1, and (a−3) may be 8×8 when the TU size flag is 2.

As another example, (b) if the size of the current coding unit is 32×32 and a minimum transformation unit size is 32×32, (b−1) then the size of the transformation unit may be 32×32 when the TU size flag is 0. Here, the TU size flag cannot be set to a value other than 0, since the size of the transformation unit cannot be smaller than 32×32.

As another example, (c) if the size of the current coding unit is 64×64 and a maximum TU size flag is 1, then the TU size flag may be 0 or 1. Here, the TU size flag cannot be set to a value other than 0 or 1.

Thus, if it is defined that the maximum TU size flag is ‘MaxTransformSizelndex’, a minimum transformation unit size is ‘MinTransformSize’, and a transformation unit size is ‘RootTuSize’ when the TU size flag is 0, then a current minimum transformation unit size ‘CurrMinTuSize’ that can be determined in a current coding unit may be defined by Equation (1):

$$CurrMinTuSize = max ( MinTransform Size , RootTuSize / ( 2 \hat{} MaxTransform SizeIndex ) ) \qquad ( 1 )$$

Compared to the current minimum transformation unit size ‘CurrMinTuSize’ that can be determined in the current coding unit, a transformation unit size ‘RootTuSize’ when the TU size flag is 0 may denote a maximum transformation unit size that can be selected in the system. That is, in Equation (1), ‘RootTuSize/(2̂MaxTransformSizelndex)’ denotes a transformation unit size when the transformation unit size ‘RootTuSize’, when the TU size flag is 0, is split by the number of times corresponding to the maximum TU size flag, and ‘MinTransformSize’ denotes a minimum transformation size. Thus, a smaller value from among ‘RootTuSize/(2̂MaxTransformSizelndex)’ and ‘MinTransformSize’ may be the current minimum transformation unit size ‘CurrMinTuSize’ that can be determined in the current coding unit.

According to an embodiment, the maximum transformation unit size RootTuSize may vary according to the type of a prediction mode.

For example, if a current prediction mode is an inter mode, then ‘RootTuSize’ may be determined by using Equation (2) below. In Equation (2), ‘MaxTransformSize’ denotes a maximum transformation unit size, and ‘PUSize’ denotes a current prediction unit size.

RootTuSize=min(MaxTransformSize,PUSize) (2)

That is, if the current prediction mode is the inter mode, the transformation unit size ‘RootTuSize’, when the TU size flag is 0, may be a smaller value from among the maximum transformation unit size and the current prediction unit size.

If a prediction mode of a current partition unit is an intra mode, ‘RootTuSize’ may be determined by using Equation (3) below. In Equation (3), ‘PartitionSize’ denotes the size of the current partition unit.

RootTuSize=min(MaxTransformSize,PartitionSize) (3)

That is, if the current prediction mode is the intra mode, the transformation unit size ‘RootTuSize’ when the TU size flag is 0 may be a smaller value from among the maximum transformation unit size and the size of the current partition unit.

However, the current maximum transformation unit size ‘RootTuSize’ that varies according to the type of a prediction mode in a partition unit is just an embodiment, and a factor for determining the current maximum transformation unit size is not limited thereto.

According to the video encoding method based on coding units of a tree structure described above with reference to FIGS. 9 through 19, image data of a spatial domain is encoded in each of the coding units of the tree structure, and the image data of the spatial domain is reconstructed in a manner that decoding is performed on each largest coding unit according to the video decoding method based on the coding units of the tree structure, so that a video that is formed of pictures and picture sequences may be reconstructed. The reconstructed video may be reproduced by a reproducing apparatus, may be stored in a storage medium, or may be transmitted via a network.

The one or more embodiments may be written as computer programs and may be implemented in general-use digital computers that execute the programs by using a non-transitory computer-readable recording medium. Examples of the non-transitory computer-readable recording medium include magnetic storage media (e.g., ROM, floppy disks, hard disks, etc.), optical recording media (e.g., CD-ROMs, or DVDs), etc.

For convenience of description, the image encoding methods and/or the video encoding method, which are described with reference to FIGS. 1A through 19, will be collectively referred to as ‘the video encoding method’. Also, the image decoding methods and/or the video decoding method, which are described with reference to FIGS. 1A through 19, will be collectively referred to as ‘the video decoding method’.

Also, a video encoding apparatus including the image encoding apparatus 40, the video encoding apparatus 100, or the image encoder 400 which are described with reference to FIGS. 1A through 19 will be collectively referred to as a ‘video encoding apparatus’. Also, a video decoding apparatus including the image decoding apparatus 30, the video decoding apparatus 200, or the image decoder 500 which are described with reference to FIGS. 1A through 20 will be collectively referred to as a ‘video decoding apparatus’.

A non-transitory computer-readable recording medium storing a program, e.g., a disc 26000, according to an embodiment will now be described in detail.

FIG. 20 illustrates a physical structure of the disc 26000 in which a program is stored, according to various embodiments. The disc 26000, as a storage medium, may be a hard drive, a compact disc-read only memory (CD-ROM) disc, a Blu-ray disc, or a digital versatile disc (DVD). The disc 26000 includes a plurality of concentric tracks Tr that are each divided into a specific number of sectors Se in a circumferential direction of the disc 26000. In a specific region of the disc 26000, a program that executes the quantized parameter determining method, the video encoding method, and the video decoding method described above may be assigned and stored.

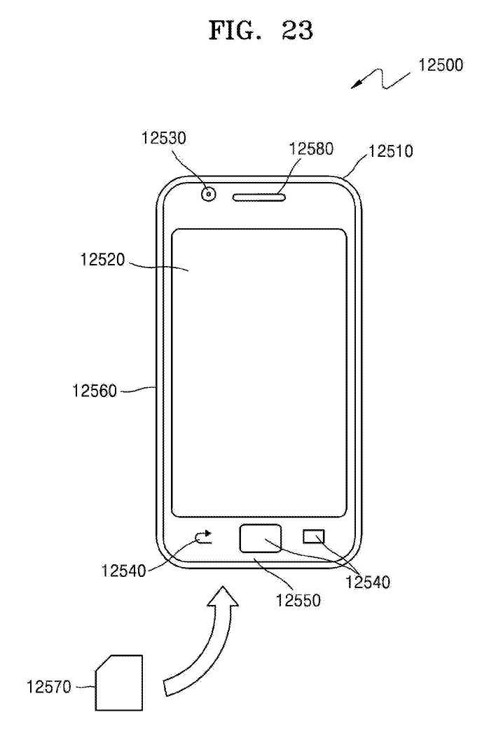

A computer system embodied using a storage medium that stores a program for executing the video encoding method and the video decoding method as described above will now be described with reference to FIG. 22.

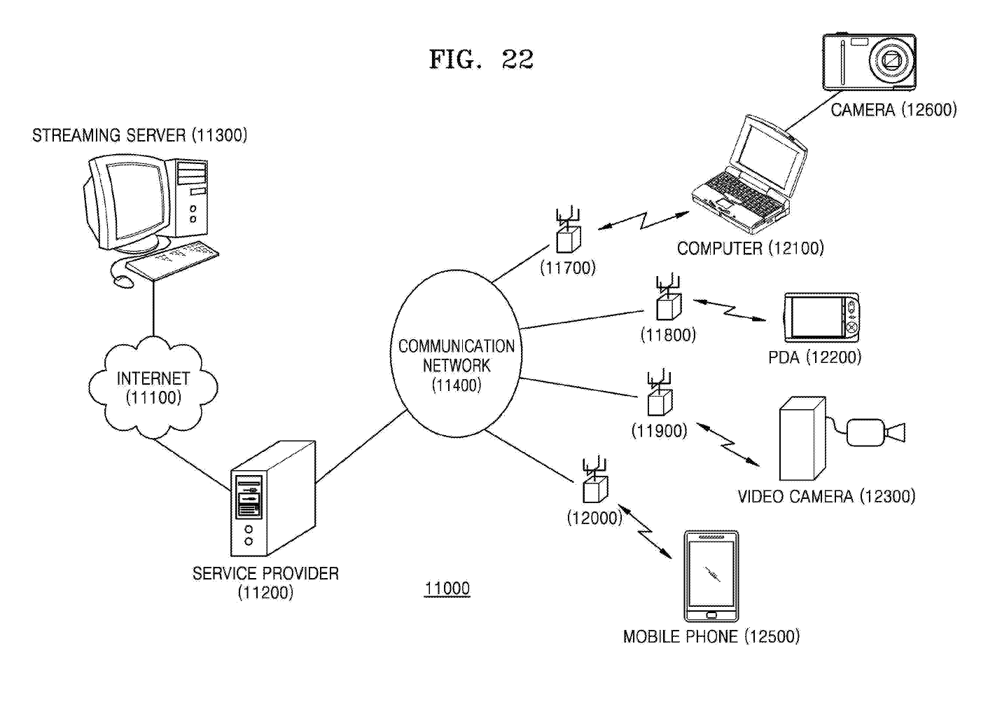

FIG. 21 illustrates a disc drive 26100 for recording and reading a program by using the disc 26000. A computer system 26700 may store a program that executes at least one of the video encoding method and the video decoding method according to an embodiment, in the disc 26000 via the disc drive 26100. In order to run the program stored in the disc 26000 in the computer system 26700, the program may be read from the disc 26000 and may be transmitted to the computer system 26700 by using the disc drive 26100.

The program that executes at least one of the video encoding method and the video decoding method according to an embodiment may be stored not only in the disc 26000 illustrated in FIGS. 20 and 21 but may also be stored in a memory card, a ROM cassette, or a solid state drive (SSD).

A system to which the video encoding method and the video decoding method according to the embodiments described above are applied will be described below.

FIG. 22 illustrates an overall structure of a content supply system 11000 for providing a content distribution service. A service area of a communication system is divided into predetermined-sized cells, and wireless base stations 11700, 11100, 11200, and 12000 are installed in these cells, respectively.

The content supply system 11000 includes a plurality of independent devices. For example, the plurality of independent devices, such as a computer 12100, a personal digital assistant (PDA) 12200, a video camera 12300, and a mobile phone 12500, are connected to the Internet 11100 via an internet service provider 11200, a communication network 11400, and the wireless base stations 11700, 11100, 11200, and 12000.

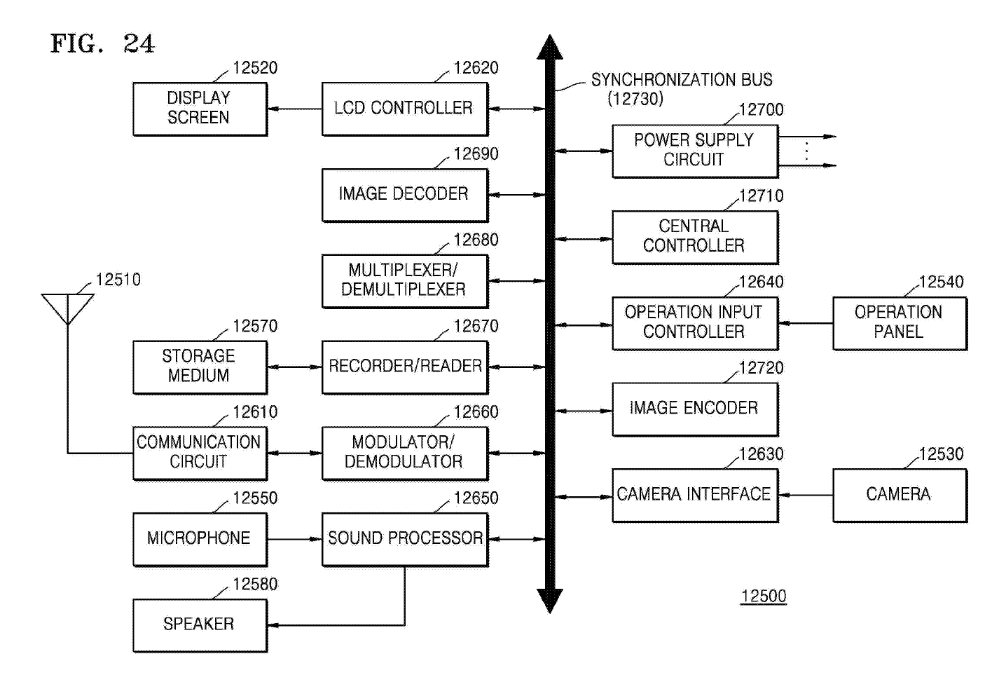

However, the content supply system 11000 is not limited to as illustrated in FIG. 23, and devices may be selectively connected thereto. The plurality of independent devices may be directly connected to the communication network 11400, not via the wireless base stations 11700, 11100, 11200, and 12000.

The video camera 12300 is an imaging device, e.g., a digital video camera, which is capable of capturing video images. The mobile phone 12500 may employ at least one communication method from among various protocols, e.g., Personal Digital Communications (PDC), Code Division Multiple Access (CDMA), Wideband-Code Division Multiple Access (W-CDMA), Global System for Mobile Communications (GSM), and Personal Handyphone System (PHS).

The video camera 12300 may be connected to a streaming server 11300 via the wireless base station 11200 and the communication network 11400. The streaming server 11300 allows content received from a user via the video camera 12300 to be streamed via a real-time broadcast. The content received from the video camera 12300 may be encoded by the video camera 12300 or the streaming server 11300. Video data captured by the video camera 12300 may be transmitted to the streaming server 11300 via the computer 12100.

Video data captured by a camera 12600 may also be transmitted to the streaming server 11300 via the computer 12100. The camera 12600 is an imaging device capable of capturing both still images and video images, similar to a digital camera. The video data captured by the camera 12600 may be encoded using the camera 12600 or the computer 12100. Software that performs encoding and decoding video may be stored in a non-transitory computer-readable recording medium, e.g., a CD-ROM disc, a floppy disc, a hard disc drive, an SSD, or a memory card, which may be accessed by the computer 12100.

If video data is captured by a camera built in the mobile phone 12500, the video data may be received from the mobile phone 12500.

The video data may be encoded by a large scale integrated circuit (LSI) system installed in the video camera 12300, the mobile phone 12500, or the camera 12600.

The content supply system 11000 may encode content data recorded by a user using the video camera 12300, the camera 12600, the mobile phone 12500, or another imaging device, e.g., content recorded during a concert, and may transmit the encoded content data to the streaming server 11300. The streaming server 11300 may transmit the encoded content data in a type of a streaming content to other clients that request the content data.

The clients are devices capable of decoding the encoded content data, e.g., the computer 12100, the PDA 12200, the video camera 12300, or the mobile phone 12500. Thus, the content supply system 11000 allows the clients to receive and reproduce the encoded content data. Also, the content supply system 11000 allows the clients to receive the encoded content data and decode and reproduce the encoded content data in real time, thereby enabling personal broadcasting.

Encoding and decoding operations of the plurality of independent devices included in the content supply system 11000 may be similar to those of the video encoding apparatus and the video decoding apparatus according to an embodiment.

With reference to FIGS. 23 and 24, the mobile phone 12500 included in the content supply system 11000 according to an embodiment will now be described in detail.

FIG. 23 illustrates an external structure of the mobile phone 12500 to which a video encoding method and a video decoding method are applied, according to various embodiments. The mobile phone 12500 may be a smart phone, the functions of which are not limited and a large number of the functions of which may be changed or expanded.

The mobile phone 12500 includes an internal antenna 12510 via which a radio-frequency (RF) signal may be exchanged with the wireless base station 12000, and includes a display screen 12520 for displaying images captured by a camera 12530 or images that are received via the antenna 12510 and decoded, e.g., a liquid crystal display (LCD) or an organic light-emitting diode (OLED) screen. The mobile phone 12500 includes an operation panel 12540 including a control button and a touch panel. If the display screen 12520 is a touch screen, the operation panel 12540 further includes a touch sensing panel of the display screen 12520. The mobile phone 12500 includes a speaker 12580 for outputting voice and sound or another type of a sound output unit, and a microphone 12550 for inputting voice and sound or another type of a sound input unit. The mobile phone 12500 further includes the camera 12530, such as a charge-coupled device (CCD) camera, to capture video and still images. The mobile phone 12500 may further include a storage medium 12570 for storing encoded/decoded data, e.g., video or still images captured by the camera 12530, received via email, or obtained according to various ways; and a slot 12560 via which the storage medium 12570 is loaded into the mobile phone 12500. The storage medium 12570 may be a flash memory, e.g., a secure digital (SD) card or an electrically erasable and programmable read only memory (EEPROM) included in a plastic case.

FIG. 24 illustrates an internal structure of the mobile phone 12500. In order to systemically control parts of the mobile phone 12500 including the display screen 12520 and the operation panel 12540, a power supply circuit 12700, an operation input controller 12640, an image encoder 12720, a camera interface 12630, an LCD controller 12620, an image decoder 12690, a multiplexer/demultiplexer 12680, a recording/reading unit 12670, a modulation/demodulation unit 12660, and a sound processor 12650 are connected to a central controller 12710 via a synchronization bus 12730.

If a user operates a power button and sets from a ‘power off’ state to a ‘power on’ state, the power supply circuit 12700 supplies power to all the parts of the mobile phone 12500 from a battery pack, thereby setting the mobile phone 12500 to an operation mode.

The central controller 12710 includes a CPU, a read-only memory (ROM), and a random access memory (RAM).

While the mobile phone 12500 transmits communication data to the outside, a digital signal is generated by the mobile phone 12500 under control of the central controller 12710. For example, the sound processor 12650 may generate a digital sound signal, the image encoder 12720 may generate a digital image signal, and text data of a message may be generated via the operation panel 12540 and the operation input controller 12640. When a digital signal is transmitted to the modulation/demodulation unit 12660 by control of the central controller 12710, the modulation/demodulation unit 12660 modulates a frequency band of the digital signal, and a communication circuit 12610 performs digital-to-analog conversion (DAC) and frequency conversion on the frequency band-modulated digital sound signal. A transmission signal output from the communication circuit 12610 may be transmitted to a voice communication base station or the wireless base station 12000 via the antenna 12510.

For example, when the mobile phone 12500 is in a conversation mode, a sound signal obtained via the microphone 12550 is transformed into a digital sound signal by the sound processor 12650, by control of the central controller 12710. The digital sound signal may be transformed into a transformation signal via the modulation/demodulation unit 12660 and the communication circuit 12610, and may be transmitted via the antenna 12510.

When a text message, e.g., email, is transmitted during a data communication mode, text data of the text message is input via the operation panel 12540 and is transmitted to the central controller 12610 via the operation input controller 12640. By control of the central controller 12610, the text data is transformed into a transmission signal via the modulation/demodulation unit 12660 and the communication circuit 12610 and is transmitted to the wireless base station 12000 via the antenna 12510.

In order to transmit image data during the data communication mode, image data captured by the camera 12530 is provided to the image encoder 12720 via the camera interface 12630. The captured image data may be directly displayed on the display screen 12520 via the camera interface 12630 and the LCD controller 12620.

A structure of the image encoder 12720 may correspond to that of the video encoding apparatus 100 according to an embodiment. The image encoder 12720 may transform the image data received from the camera 12530 into compressed and encoded image data according to the aforementioned video encoding method, and then output the encoded image data to the multiplexer/demultiplexer 12680. During a recording operation of the camera 12530, a sound signal obtained by the microphone 12550 of the mobile phone 12500 may be transformed into digital sound data via the sound processor 12650, and the digital sound data may be transmitted to the multiplexer/demultiplexer 12680.

The multiplexer/demultiplexer 12680 multiplexes the encoded image data received from the image encoder 12720, together with the sound data received from the sound processor 12650. A result of multiplexing the data may be transformed into a transmission signal via the modulation/demodulation unit 12660 and the communication circuit 12610, and may then be transmitted via the antenna 12510.

While the mobile phone 12500 receives communication data from the outside, frequency recovery and analog-to-digital conversion (ADC) are performed on a signal received via the antenna 12510 to transform the signal into a digital signal. The modulation/demodulation unit 12660 modulates a frequency band of the digital signal. The frequency-band modulated digital signal is transmitted to the video decoder 12690, the sound processor 12650, or the LCD controller 12620, according to the type of the digital signal.

During the conversation mode, the mobile phone 12500 amplifies a signal received via the antenna 12510, and obtains a digital sound signal by performing frequency conversion and ADC on the amplified signal. A received digital sound signal is transformed into an analog sound signal via the modulation/demodulation unit 12660 and the sound processor 12650, and the analog sound signal is output via the speaker 12580, by control of the central controller 12710.

When during the data communication mode, data of a video file accessed at an Internet website is received, a signal received from the wireless base station 12000 via the antenna 12510 is output as multiplexed data via the modulation/demodulation unit 12660, and the multiplexed data is transmitted to the multiplexer/demultiplexer 12680.

In order to decode the multiplexed data received via the antenna 12510, the multiplexer/demultiplexer 12680 demultiplexes the multiplexed data into an encoded video data stream and an encoded audio data stream. Via the synchronization bus 12730, the encoded video data stream and the encoded audio data stream are provided to the video decoder 12690 and the sound processor 12650, respectively.

A structure of the image decoder 12690 may correspond to that of the video decoding apparatus described above. The image decoder 12690 may decode the encoded video data to obtain reconstructed video data and provide the reconstructed video data to the display screen 12520 via the LCD controller 12620, by using the aforementioned video decoding method.

Thus, the data of the video file accessed at the Internet website may be displayed on the display screen 12520. At the same time, the sound processor 12650 may transform audio data into an analog sound signal, and provide the analog sound signal to the speaker 12580. Thus, audio data contained in the video file accessed at the Internet website may also be reproduced via the speaker 12580.

The mobile phone 12500 or another type of communication terminal may be a transceiving terminal including both a video encoding apparatus and a video decoding apparatus according to an embodiment, may be a transmitting terminal including only the video encoding apparatus according to an embodiment, or may be a receiving terminal including only the video decoding apparatus according to an embodiment.

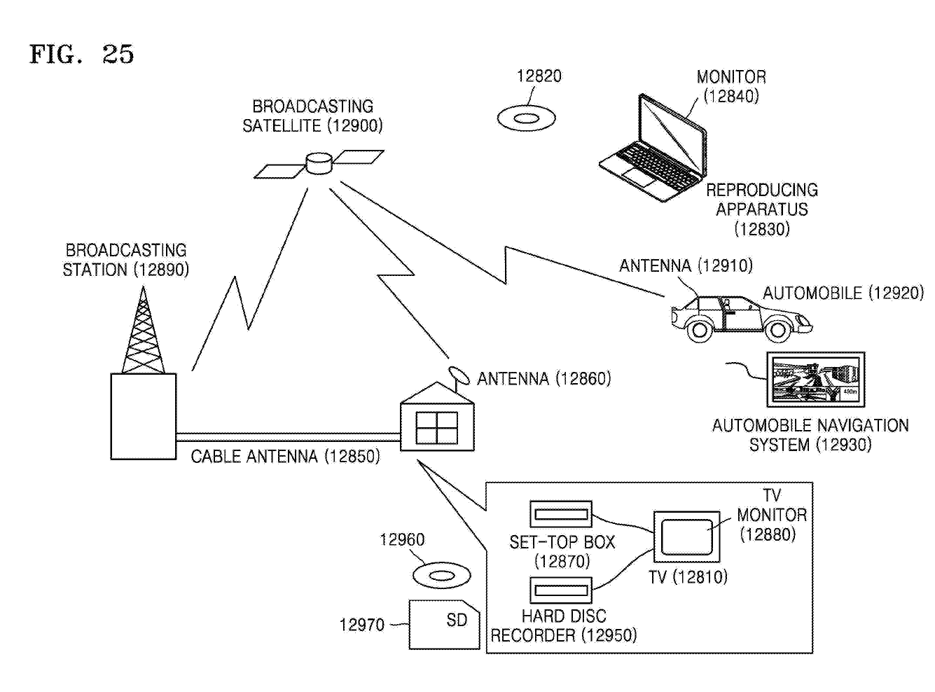

A communication system according to an embodiment is not limited to the communication system described above with reference to FIG. 24. For example, FIG. 25 illustrates a digital broadcasting system employing a communication system, according to various embodiments. The digital broadcasting system of FIG. 25 may receive a digital broadcast transmitted via a satellite or a terrestrial network by using the video encoding apparatus and the video decoding apparatus according to the embodiments.

In more detail, a broadcasting station 12890 transmits a video data stream to a communication satellite or a broadcasting satellite 12200 by using radio waves. The broadcasting satellite 12200 transmits a broadcast signal, and the broadcast signal is transmitted to a satellite broadcast receiver via a household antenna 12860. In every house, an encoded video stream may be decoded and reproduced by a TV receiver 12810, a set-top box 12870, or another device.

When the video decoding apparatus according to an embodiment is implemented in a reproducing apparatus 12130, the reproducing apparatus 12130 may parse and decode an encoded video stream recorded on a storage medium 12120, such as a disc or a memory card to reconstruct digital signals. Thus, the reconstructed video signal may be reproduced, for example, on a monitor 12840.

In the set-top box 12870 connected to the antenna 12860 for a satellite/terrestrial broadcast or a cable antenna 12850 for receiving a cable television (TV) broadcast, the video decoding apparatus according to an embodiment may be installed. Data output from the set-top box 12870 may also be reproduced on a TV monitor 12880.

As another example, the video decoding apparatus according to an embodiment may be installed in the TV receiver 12810 instead of the set-top box 12870.

An automobile 12220 that has an appropriate antenna 12210 may receive a signal transmitted from the satellite 12200 or the wireless base station 11700. A decoded video may be reproduced on a display screen of an automobile navigation system 12230 installed in the automobile 12220.

A video signal may be encoded by the video encoding apparatus according to an embodiment and may then be stored in a storage medium. In more detail, an image signal may be stored in a DVD disc 12960 by a DVD recorder or may be stored in a hard disc by a hard disc recorder 12950. As another example, the video signal may be stored in an SD card 12970. If the hard disc recorder 12950 includes the video decoding apparatus according to an embodiment, a video signal recorded on the DVD disc 12960, the SD card 12970, or another storage medium may be reproduced on the TV monitor 12880.

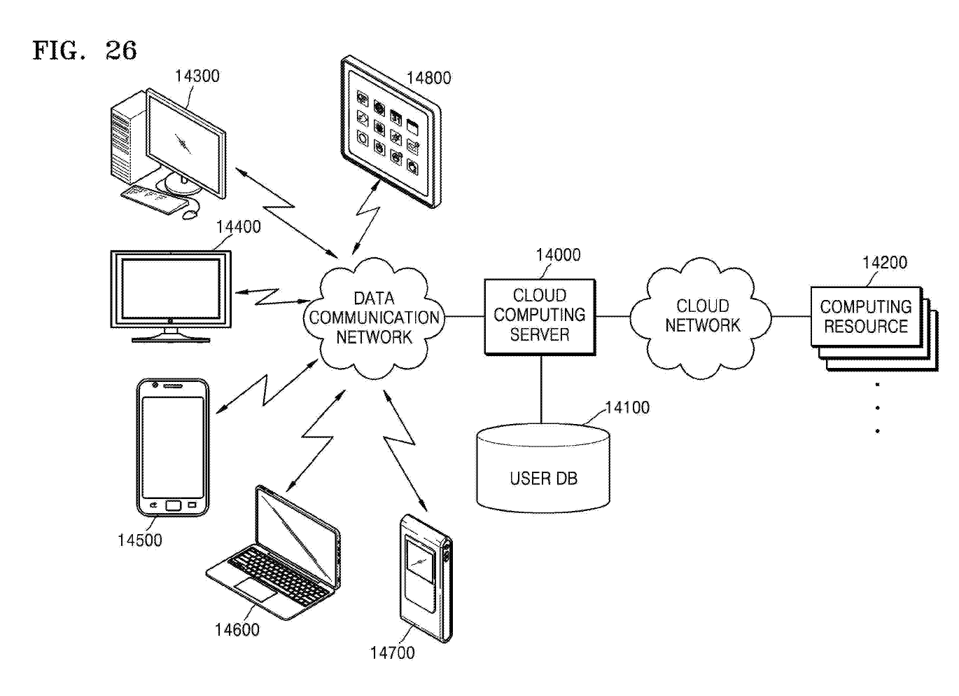

The automobile navigation system 12230 may not include the camera 12530, the camera interface 12630, and the image encoder 12720 of FIG. 26. For example, the computer 12100 and the TV receiver 12810 may not include the camera 12530, the camera interface 12630, and the image encoder 12720 of FIG. 26.

FIG. 26 illustrates a network structure of a cloud computing system using a video encoding apparatus and a video decoding apparatus, according to various embodiments.

The cloud computing system may include a cloud computing server 14000, a user database (DB) 14100, a plurality of computing resources 14200, and a user terminal.

The cloud computing system provides an on-demand outsourcing service of the plurality of computing resources 14200 via a data communication network, e.g., the Internet, in response to a request from the user terminal. Under a cloud computing environment, a service provider provides users with desired services by combining computing resources at data centers located at physically different locations by using virtualization technology. A service user does not have to install computing resources, e.g., an application, a storage, an operating system (OS), and security software, into his/her own terminal in order to use them, but may select and use desired services from among services in a virtual space generated through the virtualization technology, at a desired point in time.

A user terminal of a specified service user is connected to the cloud computing server 14000 via a data communication network including the Internet and a mobile telecommunication network. User terminals may be provided cloud computing services, and particularly video reproduction services, from the cloud computing server 14000. The user terminals may be various types of electronic devices capable of being connected to the Internet, e.g., a desktop PC 14300, a smart TV 14400, a smart phone 14500, a notebook computer 14600, a portable multimedia player (PMP) 14700, a tablet PC 14100, and the like.

The cloud computing server 14000 may combine the plurality of computing resources 14200 distributed in a cloud network and provide user terminals with a result of combining. The plurality of computing resources 14200 may include various data services, and may include data uploaded from user terminals. As described above, the cloud computing server 14000 may provide user terminals with desired services by combining video database distributed in different regions according to the virtualization technology.

User information about users who have subscribed for a cloud computing service is stored in the user DB 14100. The user information may include logging information, addresses, names, and personal credit information of the users. The user information may further include indexes of videos. Here, the indexes may include a list of videos that have already been reproduced, a list of videos that are being reproduced, a pausing point of a video that was being reproduced, and the like.

Information about a video stored in the user DB 14100 may be shared between user devices. For example, when a video service is provided to the notebook computer 14600 in response to a request from the notebook computer 14600, a reproduction history of the video service is stored in the user DB 14100. When a request to reproduce the video service is received from the smart phone 14500, the cloud computing server 14000 searches for and reproduces the video service, based on the user DB 14100. When the smart phone 14500 receives a video data stream from the cloud computing server 14000, a process of reproducing video by decoding the video data stream is similar to an operation of the mobile phone 12500 described above with reference to FIG. 24.

The cloud computing server 14000 may refer to a reproduction history of a desired video service, stored in the user DB 14100. For example, the cloud computing server 14000 receives a request to reproduce a video stored in the user DB 14100, from a user terminal. If this video was being reproduced, then a method of streaming this video, performed by the cloud computing server 14000, may vary according to the request from the user terminal, i.e., according to whether the video will be reproduced, starting from a start thereof or a pausing point thereof. For example, if the user terminal requests to reproduce the video, starting from the start thereof, the cloud computing server 14000 transmits streaming data of the video starting from a first frame thereof to the user terminal. On the other hand, if the user terminal requests to reproduce the video, starting from the pausing point thereof, the cloud computing server 14000 transmits streaming data of the video starting from a frame corresponding to the pausing point, to the user terminal.

Here, the user terminal may include the video decoding apparatus according to an embodiment as described above with reference to FIGS. 1A through 19. As another example, the user terminal may include the video encoding apparatus according to an embodiment as described above with reference to FIGS. 1A through 20. Alternatively, the user terminal may include both the video encoding apparatus and the video decoding apparatus according to an embodiment as described above with reference to FIGS. 1A through 19.

Various applications of the image encoding method, the image decoding method, the image encoding apparatus, and the image decoding apparatus described above with reference to FIGS. 1A through 19 are described above with reference to FIGS. 20 through 26. However, various embodiments of methods of storing the video encoding method and the video decoding method in a storage medium or various embodiments of methods of implementing the video encoding apparatus and the video decoding apparatus in a device described above with reference to FIGS. 1A through 19 are not limited to the embodiments of FIGS. 20 through 26.

While the present disclosure has been particularly shown and described with reference to exemplary embodiments thereof, it will be understood by those of ordinary skill in the art that various changes in form and details may be made therein without departing from the spirit and scope of the following claims. Therefore, the scope of the present disclosure is defined not by the detailed description of the present disclosure but by the appended claims, and all differences within the scope will be construed as being included in the present disclosure.

4. The method of claim 1, wherein the referring to the decoded first picture comprises, when the plurality of layers are not referred to in a same manner, referring to at least one lower layer corresponding to a layer lower than the second layer from among the plurality of layers without determining whether the first and second layers use a same decoding method,
wherein the at least one lower layer comprises the first layer.

5. The method of claim 4, wherein the performing of at least one of the inter-layer sample prediction and the inter-layer motion prediction comprises:
when it is determined that the second layer directly refers to the at least one lower layer, obtaining, from the bitstream, third information about a method of referring, by the second layer, to the at least one lower layer; and
performing at least one of the inter-layer sample prediction and the inter-layer motion prediction between the first and second layers based on the third information.

6. The method of claim 1, further comprising:
obtaining, from the bitstream, second information indicating whether the first and second layers use a same decoding method; and
when the second information indicates that the first and second layers use different decoding methods, obtaining fourth information indicating that the second layer does not refer to scaling list data on a sequence parameter set of the first layer.

7. The method of claim 1, further comprising:
obtaining, from the bitstream, second information indicating whether the first and second layers use a same decoding method; and
when the second information indicates that the first and second layers use different decoding methods, obtaining fifth information indicating that the second layer does not refer to scaling list data on a picture parameter set of the first layer.

8. The method of claim 1, further comprising:
obtaining, from the bitstream, second information indicating whether the first and second layers use a same decoding method;
when the second information indicates that the first and second layers use different decoding methods, obtaining, from the bitstream, sixth information comprising information about a maximum value of a temporal identifier of the second picture that is referred to by a third picture included in a third layer that is one of the plurality of layers; and
referring, by the third picture, to a picture having a value of a temporal identifier equal to or lower than the maximum value from the second picture based on the sixth information,
wherein the third layer corresponds to an upper layer of the second layer.

9. The method of claim 8, wherein the obtaining of the sixth information comprises determining a maximum value of a temporal identifier of the first picture that is referred to by the second picture, as a pre-determined value of a temporal identifier.

10. The method of claim 1, further comprising, after decoding of pictures referring to the first picture is completed, setting a reconstruction picture stored in a sub-decoding picture buffer of the first layer to an empty state.

11. The method of claim 1, further comprising:
obtaining, from the bitstream, second information indicating whether the first and second layers use a same decoding method; and
when the second information indicates that the first and second layers use different decoding methods, obtaining, from the bitstream, seventh information indicating whether a limitation of referring to a picture parameter set and a sequence parameter set of the first picture is applied while determining a picture parameter set and a sequence parameter set of the second picture,
wherein the seventh information indicates that the limitation is not always applied.

12. The method of claim 1, further comprising:
obtaining, from the bitstream, second information indicating whether the first and second layers use a same decoding method; and
when the second information indicates that the first and second layers use different decoding methods, obtaining, from the bitstream, eighth information indicating a maximum value of a layer identifier allowed in a coded video sequence referring to a video parameter set regarding the scalable video,
wherein the maximum value is higher than 1.

13. The method of claim 1, further comprising:
obtaining, from the bitstream, second information indicating whether the first and second layers use a same decoding method; and
when the second information indicates that the first and second layers use different decoding methods, obtaining, from the bitstream, ninth information indicating whether a limitation that data units of all video encoding layers included in an access unit of the scalable video have a same layer identifier or a limitation that a data unit of a video encoding layer of an access unit of the scalable video comprises an intra random access point (IRAP) picture is applied,
wherein the ninth information indicates that the limitation is not always applied.

14. An apparatus for decoding a scalable video comprising a plurality of layers, the apparatus comprising:
a first information obtainer configured to obtain, from a bitstream, first information indicating a number lower than, by 1, a maximum number of layers allowed to refer to a video parameter set with respect to the scalable video from among layers included in each coded video sequence;
a first picture decoder configured to decode a first picture included in a first layer; and
a second picture decoder configured to perform, by a second picture included in a second layer, at least one of inter-layer sample prediction and inter-layer motion prediction between the first layer and the second layer by referring to the decoded first picture,
wherein the first layer is a base layer corresponding to a lowest layer of the plurality of layers,
the second layer is a layer using a decoding method different from the first layer, and
when the first and second layers use different decoding methods, the first information has a value higher than 0.

15. A non-transitory computer-readable recording medium having recorded thereon a program which, when executed by a computer, performs the method of claim 1.
